(19) United States
(12) Patent Application Publication
(10) Pub. No.: US 2017/0277841 A1
(43) Pub. Date: Sep. 28, 2017

(54) SELF-LEARNING CLINICAL INTELLIGENCE SYSTEM BASED ON BIOLOGICAL INFORMATION AND MEDICAL DATA METRICS

(71) Applicant: HealthPals, Inc., San Mateo, CA (US)

(72) Inventors: Sushant Shankar, Oakland, CA (US); Rajesh Dash, San Francisco, CA (US); Nikhil Desai, Fremont, CA (US); Justin Junxuan Fu, San Diego, CA (US)

(73) Assignee: HealthPals, Inc., San Mateo, CA (US)

(21) Appl. No.: 15/467,378

(22) Filed: Mar. 23, 2017

Related U.S. Application Data
(60) Provisional application No. 62/312,226, filed on Mar. 23, 2016.

(51) Int. Cl. G06F 19/00

(52) U.S. Cl. CPC G06F 19/345; G06F 19/326

(57) ABSTRACT

Biological information and medical knowledge information are used for self-learning clinical intelligence. Medical knowledge information is assembled. Medical rules are generated based on the medical knowledge. The medical rules can be generated probabilistically. A plurality of risk models can be learned. The plurality of risk models are associated with a given disease based on patient attributes. A medical probabilistic rule graph is built based on the medical rules and the plurality of risk models. The building of the medical probabilistic rule graph is based on ordering the medical rules. Attributes from an individual patient are applied to the medical probabilistic rule graph. A diagnosis for the individual is generated from the attributes applied to the medical probabilistic rule graph. A treatment for the individual can be generated from the attributes applied to the medical probabilistic rule graph.

### RELATED APPLICATIONS

This application claims the benefit of U.S. provisional patent application “Self-learning Clinical Intelligence System Based on Biological Information and Medical Data Metrics” Ser. No. 62/312,226, filed Mar. 23, 2016, which is hereby incorporated by reference in its entirety.

### FIELD OF ART

This application relates generally to medical analysis and more particularly to a self-learning clinical intelligence system based on biological information and medical knowledge information.

### BACKGROUND

Data is everywhere. It is collected for a myriad of purposes such as market research, political polling, tracking, and billing, to name only a few. Included in the set of collected data is medical data. Medical data is one specific type of data that is ubiquitous today and is used for a variety of formal and informal purposes. Formal uses of medical data include electronic medical records (EMR) which are collected every time a patient visits her or his doctor, analysis of clinical data from various studies, and so on. Informal examples of medical data can include that kept by an individual to track weight, number of cigarettes smoked, number of alcoholic drinks consumed per week, and so on. Whatever the source of the data, the data is stored for current and future use. The stored medical data is used for research and analysis purposes and is used to provide healthcare to an individual, to track occurrence of various diseases and medical conditions, as well as to track the spread of infections, diseases, etc.

There are numerous doctors worldwide treating hundreds of millions of patients. These physicians can collectively generate billions of medical records. The doctors treat their patients based on their knowledge of medical best practices and the constraints of the situation. For example, a patient may have fallen off his bicycle and injured his arm. The doctor may want to take an x-ray of the arm to confirm her suspicion of a broken bone. The only available x-ray machine may be too far away or too expensive to use. Therefore, the doctor will treat her patient based on her knowledge of medical best practices and the constraints of the situation (e.g. no x-ray machine available). This kind of scenario is repeated hundreds, if not thousands, of times each day around the world. Each scenario has a medical condition, a treatment, and an outcome of that treatment. Each element of each scenario has the potential to add to patient medical records.

Some diseases or conditions are more serious than others and as such have much more drastic consequences. For example, a sliver lodged underneath a fingernail may prove to be extremely painful, but in and of itself, it would not be considered life threatening. However, a small scratch in the skin that causes almost no pain but allows the invasion of staph bacteria which subsequently goes septic can be an extremely life threatening situation. For certain diseases or conditions, treatment may include only one primary component. For other diseases or conditions, treatment may include several treatment components. In some cases, treatments are primarily related to taking a prescription drug, such as an antibiotic for a bacterial infection. In some cases, treatments are primarily related to near-term patient action, such as getting additional rest or seeing a physical therapist. In some other cases, treatments are primarily related to patient lifestyle changes, such as quitting smoking to help with respiratory issues. In still other cases, a combination of treatments is appropriate. All the types of treatments for all of the diseases and conditions of the hundreds of millions of patients can generate many billions of pieces of medical data.

### SUMMARY

Medical knowledge information is assembled. The medical knowledge can be derived from medical literature. The medical knowledge can be derived from medical best practices. Medical guidelines are generated based on the medical knowledge. These medical rules can be generated probabilistically. A plurality of risk models can be learned. The plurality of risk models are associated with a given disease based on patient attributes. A medical probabilistic rule graph is built based on the medical rules and the plurality of risk models. The building of the medical probabilistic rule graph is based on ordering the medical rules. Attributes from an individual patient are applied to the medical probabilistic rule graph. A diagnosis is generated from the attributes applied to the medical probabilistic rule graph for the individual patient. A treatment can be generated from the attributes applied to the medical probabilistic rule graph for the individual patient. Learning the plurality of risk models can be further based on a result of the treatment for the individual patient. The medical rules graph can include a directed acyclic graph. The learning the plurality of risk models can comprise building a machine learning model. The machine learning model can be accomplished with unsupervised feature learning that uses non-linear combinations of patient attributes. The learning the plurality of risk models can comprise deep computational learning.

A computer-implemented method for medical analysis is disclosed comprising: assembling medical knowledge information; generating medical rules based on the medical knowledge information; learning, using one or more processors, a plurality of risk models associated with a given disease based on patient attributes; building a medical probabilistic rule graph based on the medical rules and the plurality of risk models wherein the building is based on ordering the medical rules; and applying attributes, from an individual patient, to the medical probabilistic rule graph to generate a diagnosis for the individual patient. In embodiments, a computer program product embodied in a non-transitory computer readable medium for medical analysis, the computer program product comprising code which causes one or more processors to perform operations of: assembling medical knowledge information; generating medical rules based on the medical knowledge information; learning a plurality of risk models associated with a given disease based on patient attributes; building a medical probabilistic rule graph based on the medical rules and the plurality of risk models wherein the building is based on ordering the medical rules; and applying attributes, from an individual patient, to the medical probabilistic rule graph to generate a diagnosis for the individual patient. In some embodiments, a computer system for medical analysis comprising: a memory which stores instructions; one or more processors attached to the memory wherein the one or more processors, when executing the instructions which are stored, are configured to: assemble medical knowledge information; generate medical rules based on the medical knowledge information; learn a plurality of risk models associated with a given disease based on patient attributes; build a medical probabilistic rule graph based on the medical rules and the plurality of risk models wherein the building is based on ordering the medical rules; and apply attributes, from an individual patient, to the medical probabilistic rule graph to generate a diagnosis for the individual patient.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for medical analysis and learning.

FIG. 2 is a flow diagram for building a machine learning model.

FIG. 3 is an architecture block diagram for medical analysis and learning.

FIG. 4A illustrates medical analysis for diabetes.

FIG. 4B illustrates medical analysis for heart disease risk.

FIG. 4C illustrates medical analysis for breast cancer.

FIG. 5 is an example medical probabilistic rule graph.

FIG. 6 shows medical analysis and learning using rules and probabilistic rule graphs.

FIG. 7 illustrates natural language processing of patient data.

FIG. 8 shows demographically influenced diagnosis and treatment plans.

FIG. 9 shows patient knowledge representation and rule application.

FIG. 10 shows diagnosis and treatment interactions for ASCVD.

FIG. 11 is an example clinical intelligence for the doctor.

FIG. 12 shows clinical intelligence treatment recommendations and plans.

FIG. 13 is an example treatment plan of an individual for the care team.

FIG. 14 is an example treatment plan for an individual patient.

FIG. 15 is an example patient status based on medical analysis and learning.

FIG. 16 illustrates a system for patient and doctor interaction.

FIG. 17 illustrates natural language processing for application of criteria to patient data.

FIG. 18 illustrates a self-learning clinical intelligence system.

### DETAILED DESCRIPTION

Medical research, clinical trials, and other investigations regularly yield new recommendations related to a wide variety of medical ailments. The recommendations can include medical knowledge information and guidelines used for diagnosis and treatment of the ailments. The medical ailments can include cardiovascular disease (CVD) and can be based on various risk factors such as weight, high blood pressure and blood sugar levels, and habits such as smoking and alcohol consumption. The recommendations are used in analyzing patient information and for diagnosing the ailments, identifying and treating various diseases and other medical conditions, etc. The challenge faced by medical practitioners who rely on the medical knowledge information to properly diagnose and treat ailments, is that the medical knowledge information they use to inform their decisions can change quickly and often. The medical knowledge information can be widely dispersed because it can be stored and made available in a variety of locations including public and private repositories. In addition, the medical knowledge information can be published in medical and other journals. Further complicating the use of medical knowledge information is incompatibility among the various representations of the metrics.

In this technique for medical analysis, medical knowledge information is assembled. The medical knowledge information can be derived from medical literature. The medical knowledge information can be derived by scrubbing medical literature on a periodic basis. The medical literature can consist of guidelines and information on evidence for the guidelines. The medical literature can include published papers that contain diagnosis or treatment recommendations based on medical knowledge information. The medical knowledge information can be derived from medical best practices. Both medical literature and medical best practices are captured in many different formats and media. Medical literature can be in the form of print media, digital media, conference presentations, medical journals, symposia presentations, etc. Medical best practices can be in the form of print media, digital media, various presentations, etc., as well as in published guidelines by various medical organizations. Such varied and disparate formats can be formed into a consistent knowledge representation based on the medical knowledge information. The forming of the knowledge representation can be based on medical entities. Medical entities can include patient attributes, patient medical state, patient treatment, and patient events that happen during care, to name just a few. The assembling can include standardizing a medical vocabulary. This can be very beneficial because medical names, terms, diagnoses, drug names, medical entities, etc. can have several forms or representations that mean exactly the same thing. For example, some drugs are referred to in the literature with both their generic compound name and their brand name. A simple over-the-counter drug name example is the use of “acetaminophen” and “Tylenol®” to refer to the same drug. It is apparent, then, that a consistent knowledge representation using a standardized medical vocabulary is beneficial for assembling medical knowledge information.

Medical rules are generated based on the medical knowledge information. The medical rules generated are in a consistent format. The format can be a natural language format, although other formats can be used. The generating medical rules can include resolving inconsistent or incomplete medical knowledge information. For example, certain demographics of individuals can be more susceptible to certain diseases. There can be male/female susceptibility differences, such as for breast cancer. However, enough consistent data may not be available for male breast cancer to provide complete medical knowledge information for the male demographic, so rules must be resolved despite the deficiencies. One resolution can be to extrapolate from female breast cancer medical knowledge information. Other such inconsistent or incomplete medical knowledge information may exist for other demographics, such as age, race, nationality, and so on. The knowledge representation of the medical information data can be used in the generating of the medical rules.

A plurality of risk models can be learned, using one or more processors. The learning can comprise building a machine learning model. The machine learning model can be accomplished with unsupervised feature learning using non-linear combinations of patient attributes. The patient attributes can include individual biological information and medical knowledge information. Learning the plurality of risk models can comprise deep computational learning. The plurality of risk models can be based on demographics. The demographics can include age, gender, race, or geographic location, to name just a few. The plurality of risk models can be associated with a given disease based on patient attributes. The plurality of risk models can be further learned based on the result of a treatment for an individual patient. Learning risk models based on the result of a treatment for an individual patient can make valuable contributions back into the known medical best practices. Thus the incorporation of a closed loop feedback system to actually improve medical best practices is an important object of this invention.

A medical probabilistic rule graph can be built based on the medical rules and, optionally, the plurality of risk models. The building can be based on ordering the medical rules. The building of the medical probabilistic rule graph can be based on including a subset of the medical rules. The medical probabilistic rule graph can apply rules within the subset of the medical rules in a specific order based on the ordering the medical rules. The ordering can include priority, learned priority, and other such orderings. The medical probabilistic rule graph can include a directed acyclic graph.

Attributes from an individual patient are applied to the medical probabilistic rule graph. The attributes that are applied can generate a diagnosis for the individual patient. Whereas the medical probabilistic rule graph is a representation of the interrelations of the medical knowledge information and, optionally, the plurality of risk models, as ordered and built into the graph, the attributes that are applied are from an individual patient. The individual patient attributes are convolved, as it were, against the medical probabilistic rule graph to obtain specific information, such as a diagnosis, for the individual patient. The attributes can comprise biological information. The biological information can be collected from the individual. The biological information can be collected directly through interaction with a care team member or indirectly using a camera, sensors, an app, and so on. The biological information can include electronic medical records, clinical records, image data, sensor data etc. An ailment can be diagnosed to provide a diagnosis for the individual based on a contribution of risk factors for the diagnosis using the medical knowledge information and the biological information. The ailment can include cardiovascular disease. The ailment can include diabetes, cancer, and many others. An output from applying the attributes to the medical probabilistic rule graph can be accomplished using a probabilistic graph inference. That is, the decision to traverse an edge from one node to another within the graph may not be deterministic, but rather require inference based on probabilities.

In embodiments, attributes from an individual patient are applied to the medical probabilistic rule graph to generate a treatment plan for the individual patient. The treatment is based on the ailment that was diagnosed wherein the treatment is recommended to a medical practitioner through a first application programming interface and wherein the recommending of the treatment is based on machine learning factoring in previous diagnosing and recommending to other individuals of treatments with information on results of effectiveness of the treatments wherein the other individuals are associated with specific characteristics of the individual. The treatment can include time-based recommendations, which are recommendations that exist over a period of treatment time, rather than a single treatment event. The time-based recommendations can be based on simulation of conjecture scenarios. For example, edges in the medical probabilistic rule graph can be traversed in simulated scenarios that are conjectured. The treatment can include personalized recommendations for the individual patient. The personalized recommendations for the individual patient can be based on demographics of the individual patient. In embodiments, a plurality of recommendations can be recommended, and the plurality of recommendations can be prioritized. The treatments that can be recommended can be based on medical metrics and risk factors that include changeable risk factors and non-changeable risk factors. The changeable risk factors can include weight, blood pressure, exercise habits, diet, or behaviors. The non-changeable risk factors can include age, gender, prior or existing disease, ethnicity, prior social habits, and family history of disease. The specific characteristics of the individual can form the plurality of risk factors.

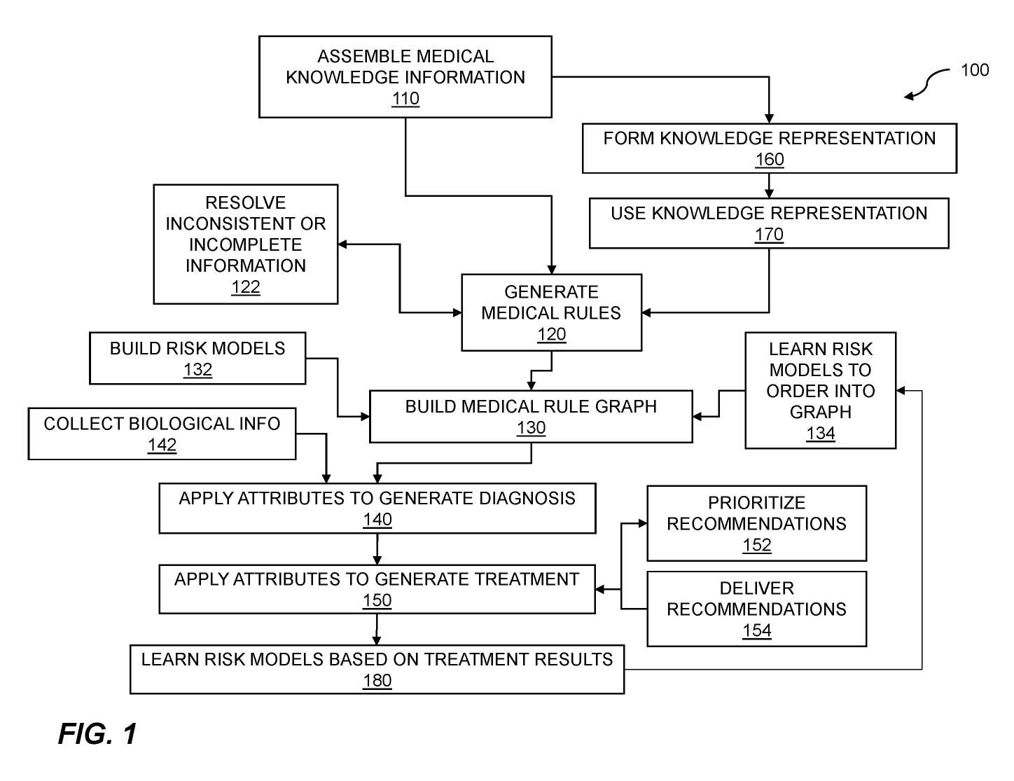

FIG. 1 is a flow diagram for medical analysis and learning. The flow 100, or portions thereof, can be implemented using a mobile device, a server, a cloud processor, and so on. The flow 100, or portions thereof, can be implemented using one or more processors. The flow 100 describes a self-learning clinical intelligence system based on biological information and medical knowledge information. The flow 100 includes assembling medical knowledge information 110. The medical knowledge information can be derived from a repository. The repository can be a private repository, a public repository, a clinical repository, a commercial repository, etc. The medical knowledge information can be derived from medical literature, where the medical literature can include medical journals, trade journals, and so on. Medical literature can include published papers, where the published papers can contain diagnosis or treatment recommendations based on medical knowledge information. The medical knowledge information can be scrubbed from the medical literature on a periodic basis. The periodicity of scrubbing the medical knowledge information from the medical literature can be based on publication frequency of the medical literature. Some of the medical literature that can be scrubbed can consist of guidelines, where the guidelines can include medical diagnosis and/or treatment. The medical knowledge information that can include recommendations for diagnosis and/or treatment, can be stored locally, be input by a user, downloaded from the Internet, and so on. The medical literature can include information on evidence for the guidelines. The flow 100 includes generating medical rules 120. The evidence for the guidelines can be used for generating the medical rules for using the guidelines. Medical metrics can be included in the medical knowledge information for generating rules and can include traditional risk factors including age, gender, or blood pressure. The risk factors can be used to diagnose disease, medical conditions, etc. The medical metrics can include non-traditional risk factors including insulin resistance, inflammatory state, values for metabolic disorders or an inflammatory state, morphometric measurements and body ratios. The medical metrics can be used to propose treatments.

Continuing with flow 100, the assembled medical knowledge information can be formed into a knowledge representation 160. The knowledge representation is a structured, consistent distillation of the widely-varied formats of the assembled medical information. The flow 100 can include using the knowledge representation 170 to generate the medical rules 120. The flow 100 can include resolving inconsistent or incomplete information 122 to generate the medical rules 120. Inconsistent or incomplete information can be reconciled by applying a more general rule to cover an incomplete case or using voting on inconsistent elements of the assembled medical knowledge information to overcome the inconsistencies. The voting can be weighted per the source of the derived medical knowledge information. In embodiments, medical knowledge information can be derived from crowdsourcing medical experts. For example, a crowdsourcing result may indicate that 68% of doctors agree with rule 1, while only 25% agree with rule 2. The crowdsourcing can be used in the face of conflicts or for general curating the quality of the generated medical rules. The medical rules can be in the form of a knowledge graph.

The flow 100 includes building a medical probabilistic rule graph 130. The medical probabilistic rule graph represents the full body of medical knowledge that is needed in the clinical context. It is represented as a graph due to the nature of the relationships between the medical entities, or nodes, which are the various medical knowledge factors, and the edges, which are the connecting possibilities between nodes of the graph. Because the nodes are only traversed in one direction, that is, leading toward a diagnosis and/or treatment, the medical probabilistic rule graph can be represented as a directed acyclic graph. This graph is used as the template for personalization for each individual, i.e. modified for each patient with specific conditions and patient attributes. The graph can be understood by looking at sub-graphs, which correspond to medical modules. For example, a preventive cardiology module will contain nodes and corresponding edges that pertain to lipid levels, measurements of inflammatory state, family history, diagnoses of hypertension, and dyslipidemia. Further traversal of the preventive cardiology module will lead to a possible diagnosis of heart disease, myocardial infarction, atherosclerosis, and the like, and a corresponding possible treatment plan of administering statin drugs, anti-hypertensive drugs, aspirin, and the like and/or propose a lifestyle change recommendation. The medical probabilistic rule graph is thus a digital representation of medical knowledge that can be convolved, as it were, with an individual patient's condition to analyze exhaustively all known medical relationships, best practices, and current research in light of an individual's situation. In embodiments, the medical probabilistic rule graph is constructed per patient while performing logical inference using the medical rules. The medical probabilistic rule graph enables efficient logical inference and facilitates inspection by humans to get an interpretable derivation. In embodiments, the medical probabilistic rule graph comprises a medical probabilistic inference graph, or simply, an inference graph. In embodiments, the inference graph enables efficient application of patient attributes.

The flow 100 can include building risk models 132. Risk models are based on medical knowledge information and related to medical rules, but the risk models focus on medical metrics and biological information that combine to indicate probabilistically certain medical risks. For example, the current best knowledge risk factors for heart disease include high blood pressure, high blood cholesterol, diabetes and prediabetes, smoking, being overweight or obese, being physically inactive, having a family history of early heart disease, having a history of preeclampsia during pregnancy, unhealthy diet, and age (55 or older for women). A risk model can be built using the known risk factors with a probabilistic traversal of the risk model, that is, factors A, B, C, and D may yield a higher risk than factors A, B, C, and E, for example. In addition, the risk models may include exposing the actual risk (well understood and accepted), exposing risk contributors (novel), and exposing what-if simulation (very novel) to provide clinical intelligence over a broader spectrum of possibilities than is normally available in a clinical setting. The risk models can be included in the building a medical probabilistic rule graph 130. In embodiments, the risk models can be included in the building a medical probabilistic inference graph.

The flow 100 includes collecting biological information 142 from an individual. The individual can be a patient, and the biological information can include current biological information such as vital signs, notes from a previous visit to a medical practitioner, and other data. The biological information can include electronic medical records. The biological information can include publicly available records, clinical records, etc. The biological information can include biosensor information. Sensors and/or cameras can collect the biosensor information, through apps, and so on. The biological information that was collected represents individual attributes for a particular patient. The biological information 142 can include measurements. The measurements can be related to patient biological information, patient medical data, sensor data, third party data, app data, and so on. The measurements can be optimized for accuracy of the measurements, precision of the measurements, receiver operating characteristic (ROC), etc.

The flow 100 includes applying the attributes to the medical rule graph to generate a diagnosis 140. The diagnosis is for an individual based on the contribution of risk factors for the diagnosis using the medical knowledge information and the biological information as represented in the medical probabilistic rule graph. More than one ailment may be diagnosed. The ailment can include cardiovascular disease based on risk factors that are known to lead to cardiovascular disease. Other ailments can include hypertension, pre-diabetes, cancer and so on. The diagnosis can include recommendations for further tests, observations, collection of biological information, etc. The diagnosing can be based on a plurality of risk factors. The specific characteristics of the individual can form the plurality of risk factors. Such risk factors can include high body mass index (BMI), high blood sugar levels, etc. The plurality of risk factors can include changeable risk factors and non-changeable risk factors. Changeable risk factors can be those over which an individual can have control, while non-changeable risk factors can be those over which an individual has no control. The changeable risk factors can include weight, blood pressure, exercise habits, diet, or behaviors such as smoking, alcohol consumption, etc. The non-changeable risk factors can include age, gender, prior or existing disease, ethnicity, prior social habits, and family history of disease.

The flow 100 includes applying attributes to the medical probabilistic rule graph to generate a treatment 150 for the individual. The treatment can be recommended to a medical practitioner through a first application programming interface (not shown) and wherein the recommending of the treatment is based on machine learning factoring in previous diagnosing and recommending to other individuals of treatments with information on results of effectiveness of the treatments wherein the other individuals are associated with specific characteristics of the individual. More than one aliment can be diagnosed. In some cases, a diagnosis can indicate that more tests or procedures are required to obtain additional information before a treatment or treatments can be recommended. The treatment can include administration of risk factor-altering medications including cholesterol-reducing medications, blood pressure controlling medications, antiplatelet medications, diabetic medications, thyroid or other hormonal medications, vitamin supplements, or lifestyle/dietary recommendations. The treatment can include recommendation of risk factor-altering behaviors such as smoking cessation, alcohol consumption reduction, exercise increase, sodium intake reduction, etc. The individual can provide desired outcome information through a second application programming interface (not shown). The outcome information can include goals such as weight loss, exercise increase, smoking cessation, and so on. The desired outcome can be applied to the medical probabilistic rule graph to produce an updated risk.

The flow 100 includes recommending a plurality of prioritized recommendations 152 on diagnosis and treatments. The plurality of recommendations can be recommended as options for treating an ailment, as recommendations for treating multiple ailments, and so on. The prioritizing of the plurality of recommendations can be made based on medical knowledge information, on risk factors, on published papers, etc. Diagnostic and/or treatment optimization can be used to prioritize the recommendations 152, which can include choosing the best action to take. The best action to take can be related to a recommended treatment for a patient. The action diagnostic and/or treatment optimization can take into account changeable risk factors, such as diet, sodium reduction, exercise, and non-changeable risk factors such as race and family history. The diagnostic and/or treatment optimization can be performed based on a clinic context, where the clinical context can include information about the patient such as name, age, gender, etc.

The flow 100 includes delivering the plurality of recommendations 154 to a medical care professional. The medical care professional can be a doctor, a nurse, a health care worker, an emergency response worker, and so on. The plurality of recommendations can be delivered to the medical care professional through the first application programming interface (API) and can be rendered on an electronic device being used by the medical care professional. The flow 100 includes learning the risk models based on treatment results 180. Once a certain treatment had been recommended and followed, the clinical results for the individual can be used to update the risk models, thus augmenting the extant body of medical knowledge information. Outcomes of applying the prioritized plurality of recommendations can be collected and analyzed. The results of the analysis can be used to augment the risk assessment, to improve diagnosis, to supplement treatments, and so on. The updated risk models can be learned to order the additional information into the medical probabilistic rule graph 134. In this way, the medical probabilistic rule graph is updated in real time with current data from, potentially, around the world.

The individual can be provided information through the second application programming interface (API). The information can relate to the ailment and/or the treatment and/or the actionable treatment goals. The information that is provided to the individual through the second API can be rendered on an electronic device being used by the individual. The electronic device can include a smart-phone, a tablet, a PDA, a laptop computer, a desktop computer, and so on. The information on the ailment or the treatment can be updated by the medical care professional. The learning the risk models based on treatment results 180 can include obtaining therapeutic result information on the treatment for the individual. The therapeutic result information can be collected from the individual using self-reporting, subsequent care provider interactions, a camera, one or more biosensors, an app, and so on. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

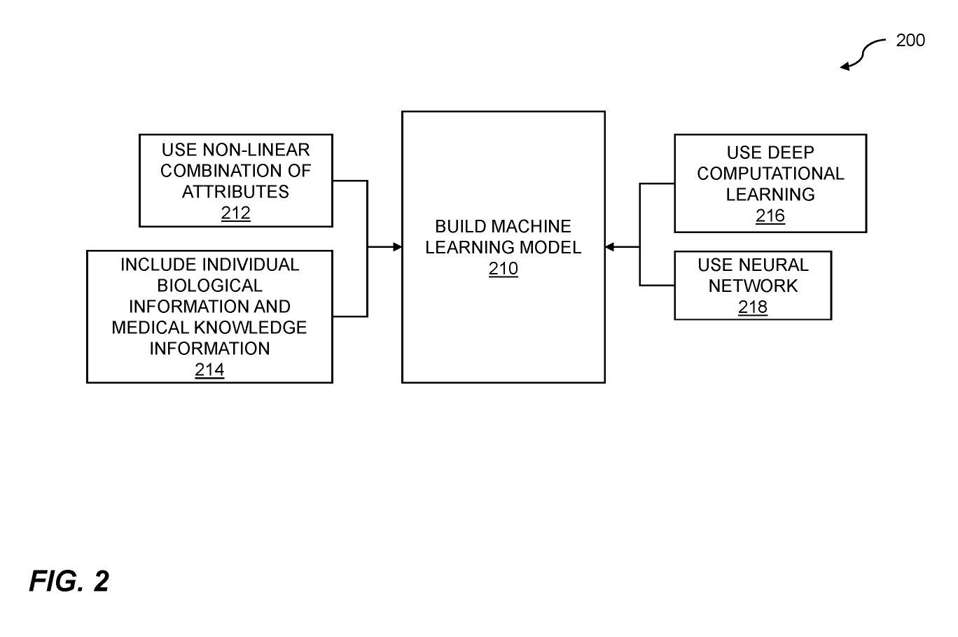

FIG. 2 is a flow diagram for building a machine learning model. The flow 200 can include building a machine learning model 210. The machine learning model is an automatic, iterative, self-learning, autonomic model updating process that provides updated risk models based on machine learning techniques. The machine learning can be based on supervised learning, unsupervised learning, reinforcement learning, and so on. The input to the machine learning can be accomplished by unsupervised feature learning using non-linear combinations of attributes 212 of the patient. The attributes can include biological information and medical data metrics 214. Various techniques can be used to implement the machine learning such as using a support vector machine (SVM). In embodiments, the machine learning can use deep computational learning 216. In embodiments, the machine learning can be accomplished by using neural networks 218. In other embodiments, the objective function of the machine learning can be the therapeutic result information. As previously discussed, the therapeutic result information can be collected from an individual using various devices including cameras and sensors. The machine learning can correlate the recommendations of diagnosis and treatment to therapeutic result information. The therapeutic result information can include biological information collected from the individual. The therapeutic result information can include risk assessment, risk factors, diagnosis, and change thereof during the treatment, optimal choice of option within the recommended treatment group, target goal to be achieved by treatment, post-treatment testing to verify the level of success of treatment, and so on. The outcome of factoring the results into the machine learning can be used to improve future recommendations of treatment through an API (not shown). Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

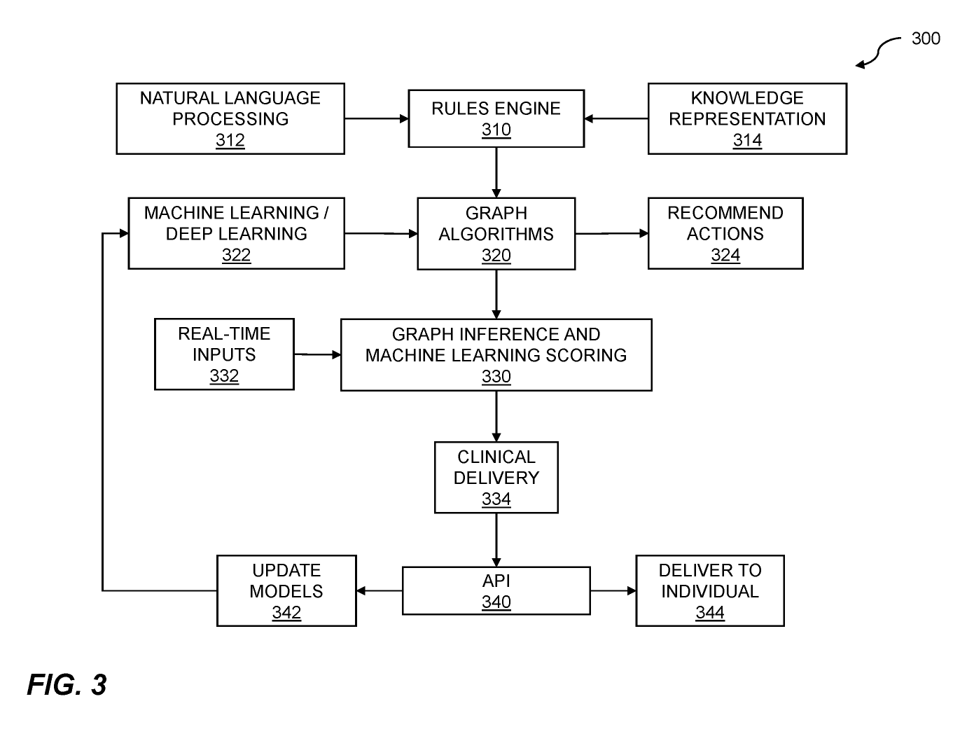

FIG. 3 is an architecture block diagram for medical analysis and learning. The block diagram 300 includes a rules engine 310. The rules engine 310 takes a structured and consistent knowledge representation 314 of all available medical knowledge information and best practices. Natural language processing 312 can be used to process the knowledge representation 314 into medical rules through the rules engine 310. The rules from rules engine 310 are ordered into nodes and edges using one or more graph algorithms 320. The resulting graph is a medical probabilistic rule graph. The graph algorithms 320 can include recommending actions 324. The graph algorithms 320 can include machine learning/deep learning 322. The graph algorithms can order the medical knowledge data rules into a directed acyclic graph (DAG). The DAG can be ordered using graph inference and machine learning scoring 330. The graph can be customized by including real-time inputs 332, such as the attributes of an individual patient. The customized graph enables providing clinical delivery 334 of diagnoses and/or treatments through application programming interface (API) 340. The API 340 can be used to deliver diagnoses/treatments to an individual 344. API 340 can be used to update the models 342. The models can be updated by evaluating treatment results and being fed back into machine learning/deep learning 322 to update risk models and DAG nodes and edges. The models can be updated by adding desired clinical outcomes and being fed back into the real-time inputs 332 to understand the relative probabilistic advantages of following clinical treatment recommendations, such as, for example, losing weight or continuing on an anti-hypertension drug. Feeding back the updated models through the machine learning/deep learning 322 into the graph algorithms 320 provides a valuable closed loop feedback path to actually improve the medical knowledge information and medical best practices captured by rules engine 310 and ordered algorithmically into a medical probabilistic directed acyclic rule graph. Various blocks in the block diagram 300 may be changed in order, repeated, omitted, or the like without departing from the disclosed concepts. Various embodiments of the block diagram 300 can be included in a computer program product embodied in a non-transitory computer readable medium that includes code executable by one or more processors. Various embodiments of the block diagram 300, or portions thereof, can be included on a semiconductor chip and implemented in special purpose logic, programmable logic, and so on.

The block diagram 300 can include providing information to and collecting information on, or from, an individual. The individual can be a patient. The delivery to an individual 344 can be through an application programming interface (API) 340 and include information on the ailment or the treatment, as well as actionable treatment goals. The ailment can include atherosclerotic cardiovascular disease (ASCVD), insulin resistance, or breast cancer, to name but a few. The treatment can include statin therapy for ASCVD. The goals can include changing diet, reducing sodium intake, quitting smoking, and so on. The delivery to the individual 344 can include collecting therapeutic result information through API 340. The therapeutic result information can include biological information from the individual, where the biological information can be collected using a camera, sensors, a survey, and so on. In embodiments, the block diagram 300 can include providing feedback information to the medical practitioner. The feedback information to the medical practitioner can be through a first API 340, and the API supporting the delivery to the individual 344 can be through a second API. The feedback to the practitioner through API 340 can be in real-time. The feedback information can include the collected patient biological information, data from electronic medical records (EMR), data from clinical records (CR), etc. The block diagram 300 can include augmenting risk assessment, diagnosis, and treatment recommendations based on the medical knowledge information captured in the knowledge representation 314. The risk assessment can change based on how well the patient is meeting treatment goals and responding to treatment. Diagnoses can vary based on additional biological information that is collected from the patient, additional medical knowledge information, and so on. Treatment recommendations can be changed or can remain the same, depending on how the patient is responding to treatment, medical knowledge information, etc.

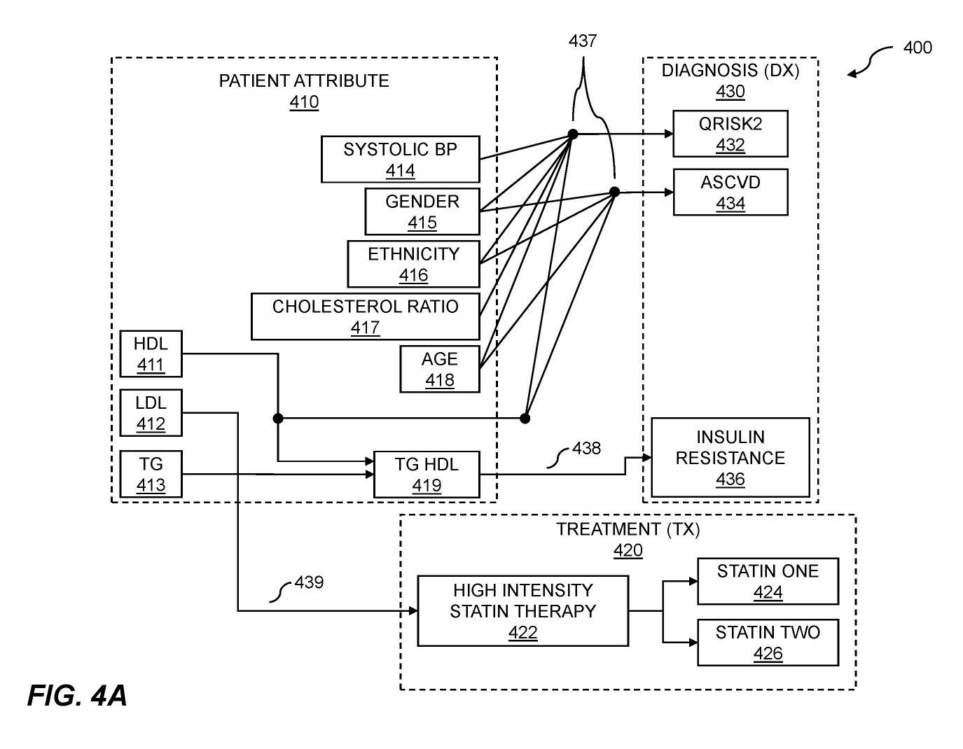

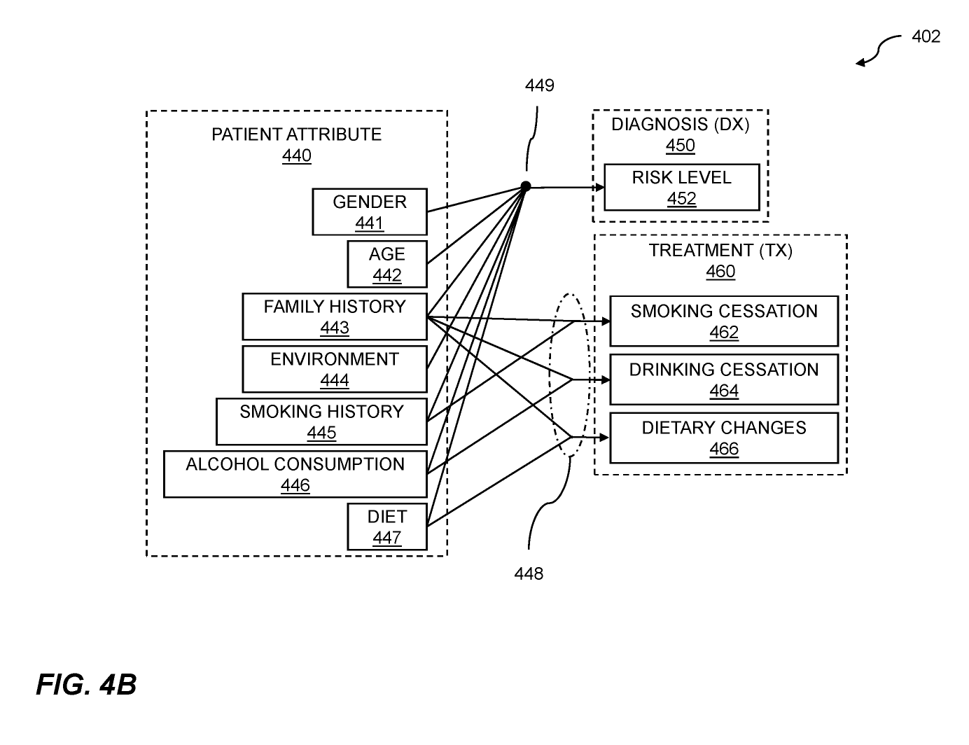

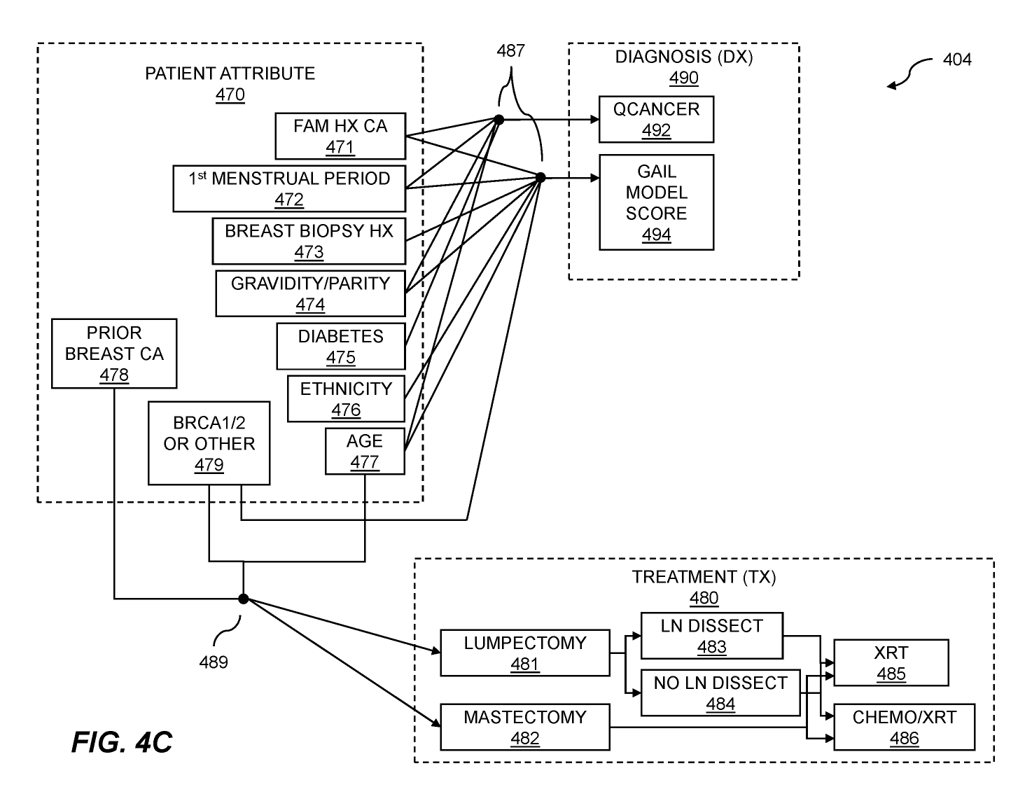

FIG. 4A illustrates medical analysis and learning for diabetes. Illustration 400 shows an example of clinical intelligence for the care team. In the patient attribute section 410—grouped illustratively by a dashed line—an individual patient's salient attributes are summarized. The patient attributes 410 can include systolic blood pressure (BP) 414, gender 415, ethnicity 416, cholesterol ratio 417, and age 418. Other attributes can be included if they are salient to the current diagnosis, in this case, diabetes. Additional salient detail on cholesterol is provided such as high-density lipoproteins (HDL) 411, low-density lipoproteins (LDL) 412, and triglycerides (TG) 413. The HDL and TG can be combined into a single salient attribute TG HDL 419. The patient attributes enable individualized traversal of the nodes of the medical probabilistic rules graph.

Illustration 400 also includes a diagnosis (Dx) section 430—also grouped illustratively by a dashed line. The Dx 430 can include risk assessments based on applying the patient attributes to the medical probabilistic rule graph. Dx 430 includes the risk assessments QRISK2 432 and ASCVD 434, which are relative risks associated with diabetes. The risks can be referred to by arbitrary terms, such as QRISK2, or by actual acronym terms such as ASCVD, which stands for atherosclerotic cardiovascular diseases. These risk assessments, QRISK2 432 and ASCVD 434 are nodes in the medical probabilistic rule graph as traversed based on patient attributes, shown illustratively by various interrelated arrows 437. Dx 430 includes insulin resistance 436, which can be an important factor describing the patient's overall diagnosis and is predicated on the TG HDL 419 value as shown by arrow 438.

FIG. 4A includes an illustrated treatment (Tx) section 420—also grouped illustratively by a dashed line. Tx 420 includes high intensity statin therapy 422, which is the recommended treatment based on the application of patient attributes to the medical probabilistic rule graph. In particular, patient LDL 412 is shown to be an important factor in the treatment recommendation, indicated by arrow 439. In addition, based on the current and best medical information data, two specific drugs are indicated, namely statin drug one 424 and statin drug two 426. The medical analysis and learning for diabetes process illustrated in FIG. 4A, or portions thereof, can be implemented using a mobile device, a server, a web interface into a cloud processor, and so on. The illustration 400, or portions thereof, can be implemented using one or more processors. The illustration 400 shows a self-learning clinical intelligence system based on biological information and medical knowledge information.

FIG. 4B illustrates medical analysis and learning for heart disease risk. Illustration 402 shows another example of clinical intelligence for the care team. In the patient attribute section 440—grouped illustratively by a dashed line—an individual patient's salient attributes are summarized for heart disease risk evaluation. The patient attributes 440 can include gender 441, age 442, family history 443, environment 444, smoking history 445, alcohol consumption 446 and diet 447. Other attributes can be included if they are salient to the current diagnosis, in this case, heart disease risk. The patient attributes enable individualized traversal of the nodes of the medical probabilistic rules graph.

Illustration 402 also includes a diagnosis (Dx) section 450—also grouped illustratively by a dashed line. The Dx 450 can include risk level assessments based on applying the patient attributes to the medical probabilistic rule graph. The risk level assessment, risk level 452, is based on traversing the nodes in the medical probabilistic rule graph based on patient attributes, shown illustratively by various interrelated arrows 449.

FIG. 4B includes an illustrated treatment (Tx) section 460, also grouped illustratively by a dashed line. Tx 460 includes smoking cessation 462, drinking cessation 464, and dietary changes 466, as illustrated by arrows 448. The medical analysis and learning for diabetes process illustrated in FIG. 4B, or portions thereof, can be implemented using a mobile device, a server, a web interface into a cloud processor, and so on. The illustration 402, or portions thereof, can be implemented using one or more processors. The illustration 402 shows a self-learning clinical intelligence system based on biological information and medical knowledge information.

FIG. 4C illustrates medical analysis and learning for breast cancer. Illustration 404 shows an example of clinical intelligence for the care team. In the patient attribute section 470—grouped illustratively by a dashed line—an individual patient's salient attributes are summarized. The patient attributes 470 can include a family history of cancer (FAM Hx CA) 471, age of first menstrual period 472, breast biopsy history (Hx) 473, gravidity/parity 474 (obstetrical history), diabetes 475, ethnicity 476, and age 477. Other attributes can be included if they are salient to the current diagnosis, in this case, breast cancer risk. Additional salient detail on the presence of certain gene mutations is included such as BRCA1 and BRCA2 or other cancer-related mutations 479. Additional salient detail such as a history of prior breast cancer (CA) 478 cholesterol is included. The patient attributes enable individualized traversal of the nodes of the medical probabilistic rules graph.

Illustration 404 also includes a diagnosis (Dx) section 490—also grouped illustratively by a dashed line. The Dx 490 can include risk assessments of breast cancer based on applying the patient attributes to the medical probabilistic rule graph. Dx 490 includes the risk assessments QCANCER 492 and Gail Model score 494, which are relative risks associated with breast cancer. The risks can be referred to by arbitrary terms, such as QCANCER, or by actual industry terms such as the Gail Model score for breast cancer risk assessment. These risk assessments, QCANCER 492 and Gail Model score 494 are nodes in the medical probabilistic rule graph as traversed based on patient attributes, shown illustratively by various interrelated arrows 487.

FIG. 4C includes an illustrated treatment (Tx) section 480—also grouped illustratively by a dashed line. Tx 480 includes a lumpectomy 481 and a mastectomy 482, which are the recommended treatments based on the application of patient attributes to the medical probabilistic rule graph. In particular, lumpectomy 481 and mastectomy 482 can be indicated by prior breast CA 478, BRCA1/2 or other mutations 479, and patient age 477, as shown by arrow 489. The lumpectomy 481 can include or not include the dissection of lymph nodes (LN). LN dissection 483 results, or no LN dissection 484, can indicate radiation therapy (XRT) 485 or chemotherapy and XRT 486. Likewise mastectomy 482 can indicate XRT 485 or chemo/XRT 486. The medical analysis and learning for diabetes process illustrated in FIG. 4C, or portions thereof, can be implemented using a mobile device, a server, a web interface into a cloud processor, and so on. The illustration 404, or portions thereof, can be implemented using one or more processors. The illustration 404 shows a self-learning clinical intelligence system based on biological information and medical knowledge information.

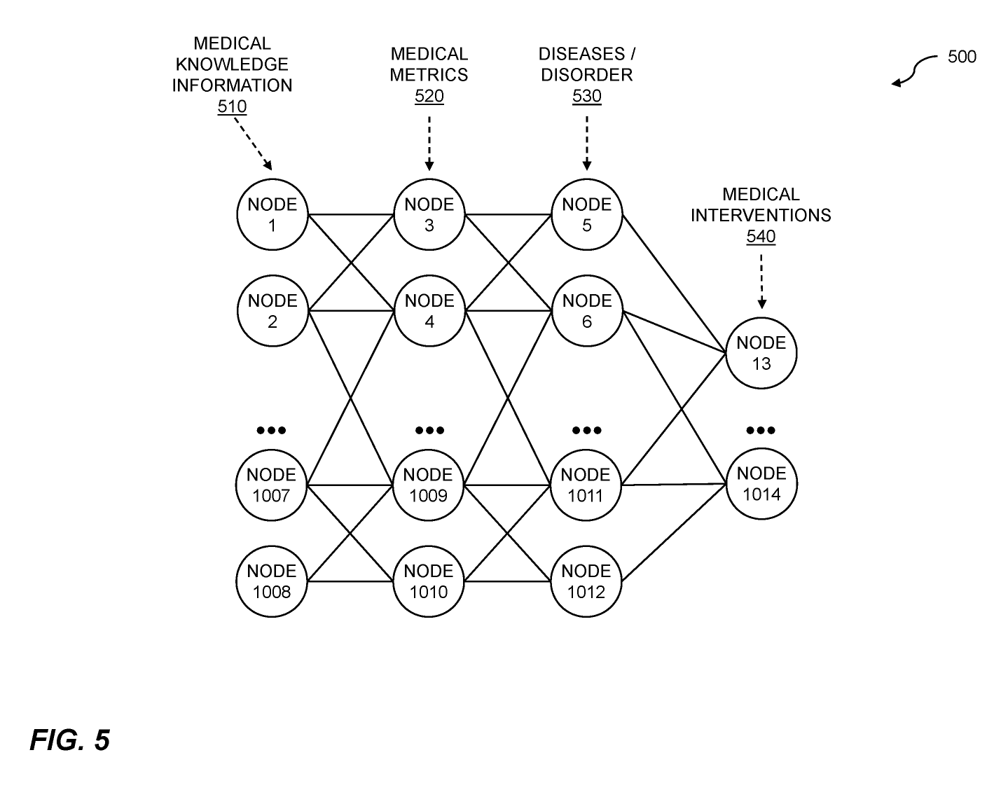

FIG. 5 is an example medical probabilistic rule graph represented as a directed acyclic graph (DAG). The example 500 includes a first column of nodes capturing medical knowledge information 510, comprising nodes 1, 2, . . . 1007, and 1008. Node 1, for example, could indicate a symptom of fainting. The medical knowledge information is structured and made consistent in a set of medical rules (not shown) for uniform digital application in the DAG. The example 500 includes a second column of nodes capturing medical metrics 520, comprising nodes 3, 4, . . . 1009, and 1010. Node 3, for example, could be the metric of high blood pressure, and Node 4, for example, could be the metric of low blood pressure. The example 500 includes a third column of nodes capturing possible ailments, or diseases and disorders 530, comprising nodes 5, 6, . . . 1011, 1012. Node 5, for example, could be the diagnosis of the heart disease. The example 500 includes a fourth column of nodes capturing medical interventions 540, or treatments, comprising node 13 . . . 1014. Node 13, for example, could be the medical intervention of taking an anti-hypertension drug.

The edges of the example graph 500, that is, the means of traversal from one node to another are determined by the assembled medical knowledge information and, additionally, learned risk models. The example graph 500 is illustrative of the medical probabilistic rule graph that represents the full body of medical knowledge that is needed in the clinical context. The example graph 500 is greatly simplified because, as is readily appreciated, the scope of the actual graph is millions of nodes and multiple millions of edges, which can only be represented in digital format for processing on one or more processors. Similarly, the concept of node columns, shown here in FIG. 5 for illustrative purposes, would quickly be lost in an actual graph comprising millions of nodes. Because the traversal of the graph never leads back to the first column, the graph is acyclic.

Actual traversal of the DAG is enabled by applying individual patient attributes. Continuing the example, an individual patient may exhibit a symptom of fainting, which could initialize the application of the medical probabilistic rule graph for that individual patient to node 1. The traversal of the edge from fainting (node 1) to either high blood pressure (node 3) or low blood pressure (node 4) would be determined by the applied patient attribute indicating either high or low blood pressure. Assuming for this example that the individual patient's blood pressure was high (node 3), a possible diagnosis could be heart disease (node 5). Given a diagnosis of heart disease (node 5), a treatment of taking an anti-hypertension drug (node 13), could be arrived, assuming traversal of the edge between nodes 5 and 13 could be accomplished based on the applied patient attribute, of, for example, no known drug allergies. The example 500 is meant to be illustrative and not limiting, because, as discussed above, a simplified example is required due to the extreme complexity of the digital traversal of the medical probabilistic rule graph. In embodiments, example 500 illustrates a computer-implemented method for medical analysis comprising: assembling medical knowledge information; generating medical rules based on the medical knowledge information; learning, using one or more processors, a plurality of risk models associated with a given disease based on patient attributes; building a medical probabilistic rule graph based on the medical rules and the plurality of risk models wherein the building is based on ordering the medical rules; and applying attributes, from an individual patient, to the medical probabilistic rule graph to generate a diagnosis for the individual patient.

FIG. 5 can be considered illustrative of medical data analysis and analytics. Medical data analysis and analytics can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. The medical data analysis sources can include electronic medical records (EMR), clinical records, and so on. The medical data analysis sources can include medical knowledge and current practices. The medical knowledge can include medical knowledge information, where the medical knowledge information can be scrubbed from the medical literature on a periodic basis. The medical literature can also include guidelines and information on evidence for the guidelines. The medical knowledge can be derived from published papers that contain diagnosis or treatment recommendations based on medical knowledge information. The sources can include information such as blood pressure, heart rate, and so on. The sources can be used as data inputs to graphs, where the graphs can include global medical rules graphs, patient specific rules graphs, and so on. Medical metrics can be applied to the data sources. Sources of the medical metrics can include third-party sensor information from consumer apps, cloud sharing etc. The medical metrics can be used to determine heart rate variability, structural heart defects, and so on. The medical metrics can be used to determine diseases and disorders, where the diseases and disorders can include coronary heart disease, prediction of heart attack, being pre-diabetic, etc.

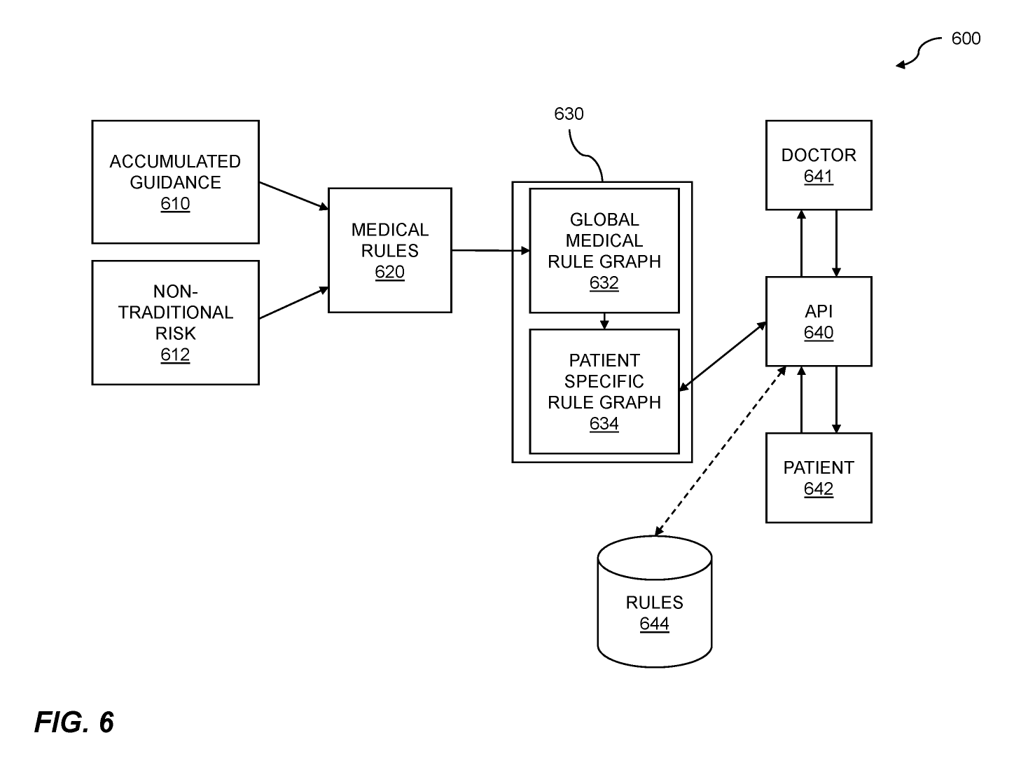

FIG. 6 shows medical analysis and learning using rules and probabilistic rule graphs. Medical rules can be analyzed and rule graphs can be generated 600 using a self-learning clinical intelligence system, which can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Medical analysis using rules and rule graphs can include accumulated guidance 610 and nontraditional risk factors 612. The accumulated guidance can include medical knowledge information, where the medical knowledge information can be derived from medical literature. The medical knowledge information can be scrubbed from the medical literature on a periodic basis. Some of the medical literature can consist of guidelines, and can include information on evidence for the guidelines. The medical metrics can include non-traditional risk factors 612 including insulin resistance, inflammatory state, values for metabolic disorders, morphometric measurements, and body ratios, etc. Medical rules 620 can be generated to consistently and uniformly represent the accumulated guidance 610 and nontraditional risk factors 612 (medical knowledge information) in a digital format.

Graphs 630 can be built based on the medical rules 620. The graphs that can be built can include a global medical rule graph 632. The global medical rule graph 632 can be based on general medical approaches to diagnosing an ailment, to recommend a treatment, and so on. The graphs that can be generated can include a patient specific rule graph 634. The patient specific rule graph can be derived from the global medical rules graph by including patient attributes such as specific information as gender, age, ethnicity, family history, and so on. The graphs 630 can be provided to an API 640. The API can communicate with a doctor, or medical practitioner 641, a patient 642, and so on. The API 640 can provide to the individual patient information on an ailment or a treatment, as well as actionable treatment goals. Rules 644 can be applied to direct how the graphs 630 can be provided to the patient 642 through the API 640. For example, using clinical, precise terms is likely most helpful for a doctor or medical practitioner, whereas using plain English terms is likely most helpful for a patient. Thus, rules 644 can format the output of API 640 appropriately. Other rules 644 can likewise direct API 640 to other appropriate outputs.

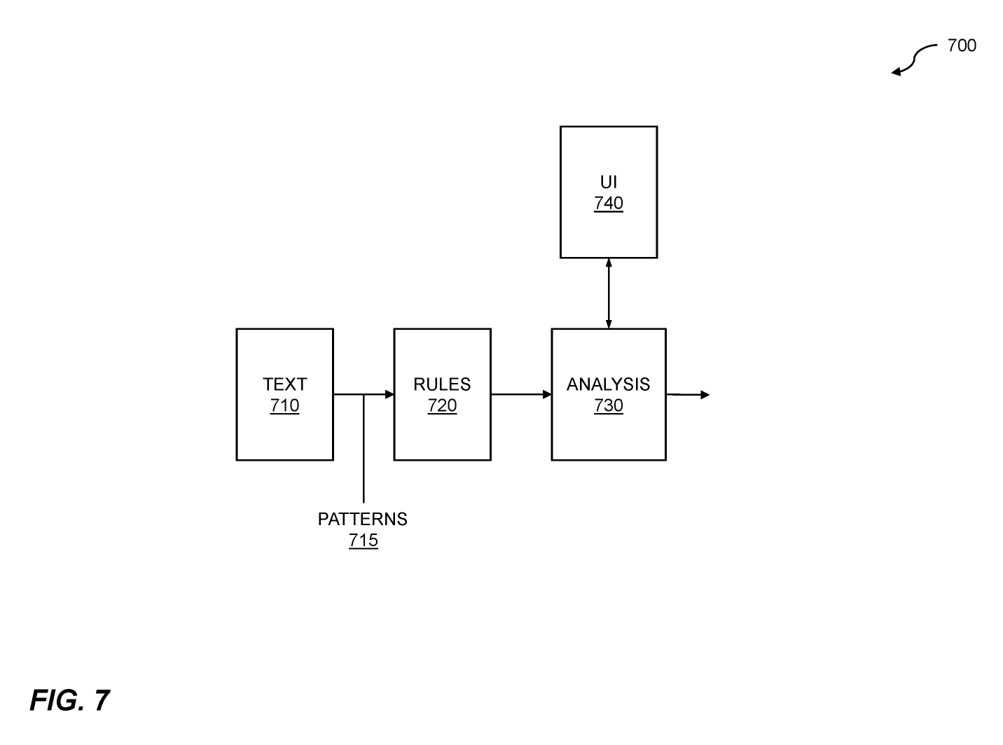

FIG. 7 illustrates natural language processing of patient data. Natural language processing of patient data 700 can be performed as part of a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Natural language (NL) text 710 can be obtained from a file, from digital medical records, input by a medical practitioner, downloaded from the Internet, and so on. Patterns 715 can be identified, and rules 720 can be applied to the NL text. Analysis 730 can be performed on the text 710 based on the rules 720 and the patterns 715 to diagnose ailments, to make recommendations for treatment, and so on. The analysis 730 can be coupled to a user interface (UI) 740. The UI can be a UI designed for a medical practitioner, a UI designed for an individual, and so on. More than one UI can be coupled to the analysis 730. The analysis 730 can be collected, stored locally, stored in digital medical records, uploaded to the Internet, etc.

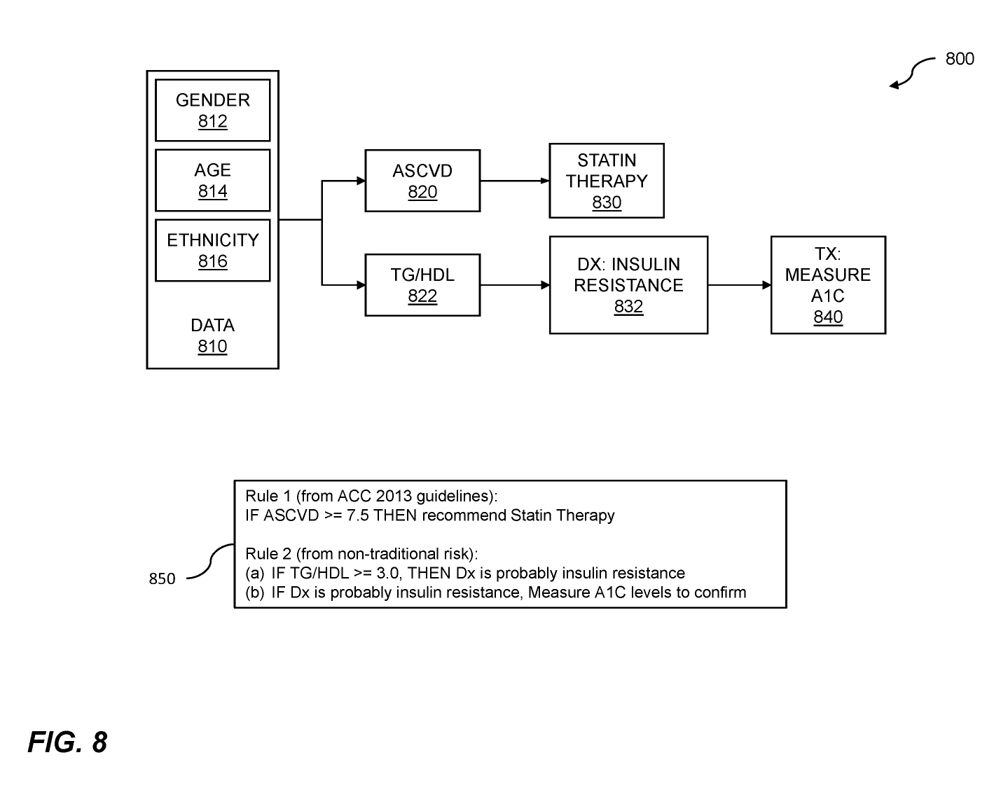

FIG. 8 shows demographically influenced diagnosis and treatment plans. Diagnosis and treatment recommendation 800 can be determined using a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Biological data and other data 810 from the individual can be read from a file, input by a medical practitioner, obtained from medical records, obtained from sensors, etc. The data 810 can include gender 812, age 814, ethnicity 816, family history (not shown), and so on. The data can be analyzed to diagnose medical conditions. The analysis of the data can include the application of rules 850, where the rules can be written in a machine-readable code, a human-readable code, natural language (NL), and so on. Various medical conditions can be included in the self-learning clinical intelligence system. The medical conditions can include atherosclerotic cardiovascular disease (ASCVD) 820, triglyceride and high-density lipoprotein (TG/HDL) 822 levels, etc. The rules 850 can be applied to the conditions 820 and 822 to determine diagnoses, to recommend treatments, etc. Based on the condition ASCVD 820, the rules 850 can recommend statin therapy 830. Based on the condition TG/HDL 822, a diagnosis of insulin resistance 832 may be determined, and a treatment recommendation of measure A1C 840 can be made.

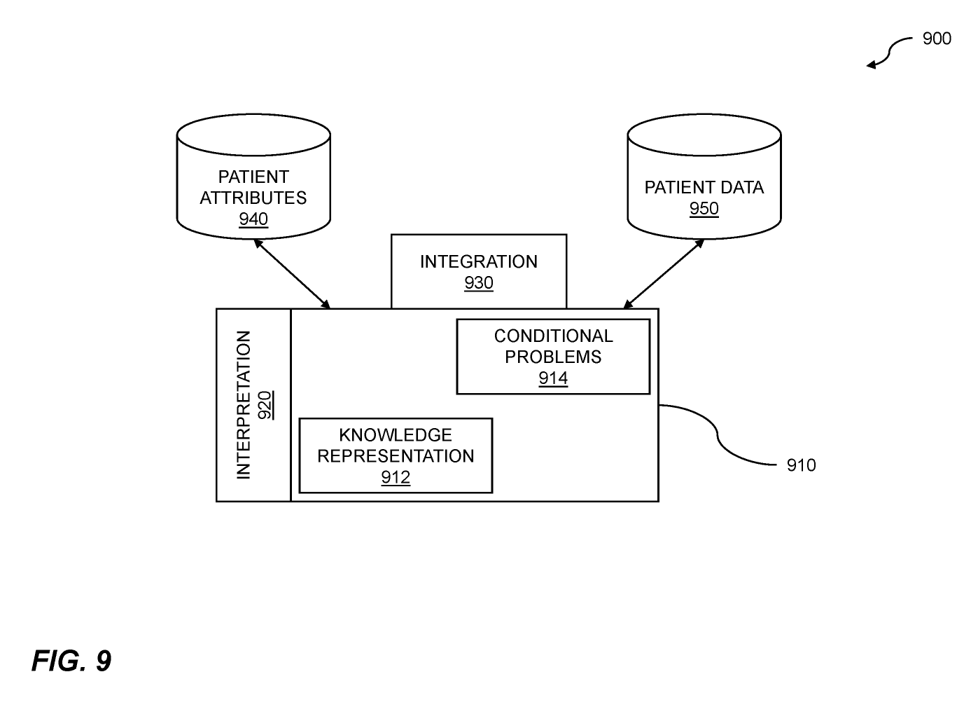

FIG. 9 shows patient knowledge representation and rule application. Patient knowledge representation and rule application 900 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Knowledge representation and rule application 900 can include a knowledgebase 910. The knowledgebase 910 can include various types of data including medical knowledge information, biological information from an individual, clinical data, and so on. The knowledgebase can include knowledge representation 912 where the knowledge representation can describe how the various types of data can be stored in the knowledgebase, such as using tuples. The knowledgebase 910 can include conditional problems 914, which can be used to describe how to analyze the data stored in the knowledgebase. The information and data stored in the knowledgebase can undergo interpretation 920. The interpretation can be based on medical taxonomies and ontologies. Interpretation can be used to diagnose an ailment, recommend a treatment, and so on. Input data can be received from electronic medical records (EMR), clinical records (CR), and so on. The interpretation can be used to process the input data and to render output data. The output data can include diagnoses, treatments, etc. The information and data stored in the knowledgebase can be integrated 930. The integration can include integration of data from various sources such as EMR, CR, etc., and can include data normalization. Patient data 950 can be obtained for input to and storage from the knowledgebase 910. Patient data can include biological data, EMR, CR, and so on. Patient attributes 940 can be obtained for input to and storage from the knowledgebase 910. Patient attributes can include gender, age, ethnicity, family history, etc.

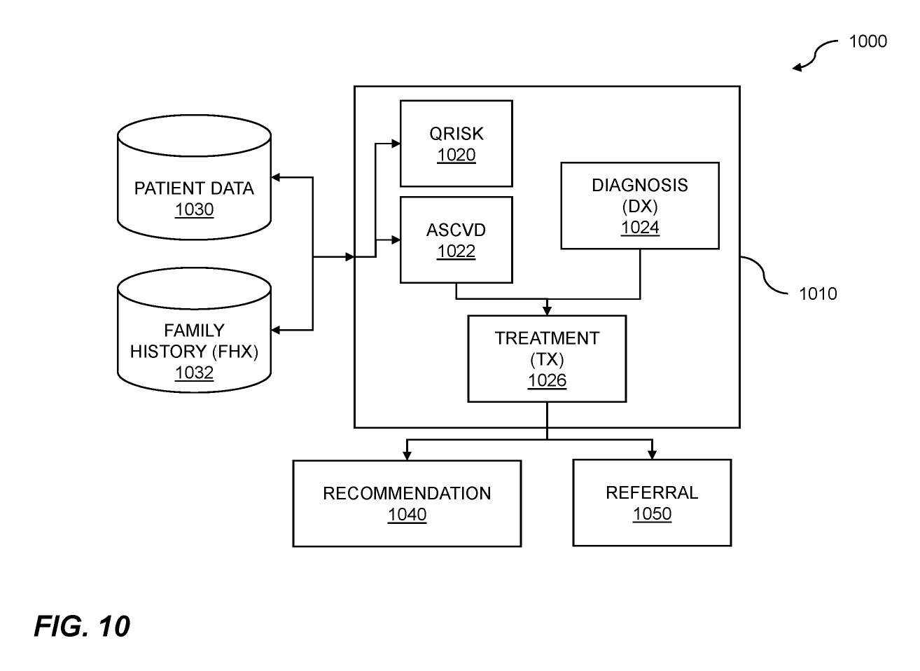

FIG. 10 shows diagnosis and treatment interactions for ASCVD. Diagnosis and treatment interactions 1000 for atherosclerotic cardiovascular disease (ASCVD) can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Diagnosis and treatment interactions for ASCVD can include an analyzer 1010 that can analyze medical and biological data. The data can include patient data 1030, where the patient data can be stored in multiple databases such as patient electronic medical records (EMR), clinical records, third party records, and so on. The data can include family history data (FHx) 1032, where the family history data can be stored in multiple databases, and where the family history data can include such family medical history as occurrences of coronary heart disease, cancer, and other health ailments. The analyzer 1010 can consider health risk assessment techniques such as QRISK 1020, a prediction algorithm for cardiovascular (CVD), and ASCVD 1022. A diagnosis (Dx) 1024 for an ailment can be provided. The diagnosis 1024 can be based on risk factors, aggregate risk assessments, and so on. Error analysis can be conducted, where the error analysis can be based on determining confidence intervals. The confidence intervals can be related to the contributions of individual risk factors to the aggregate risk factor. Error analysis for each risk can be based on the confidence interval of a risk score, a confusion matrix, and other factors including measurement precision and accuracy, recall, receiver operating characteristic (ROC), and so on. The analysis results from QRISK and ASCVD, and the diagnosis, can be used to determine a treatment (Tx) 1026. The results of determining a treatment can include making one or more recommendations 1040 to the patient and/or medical practitioner, and making a referral 1050.

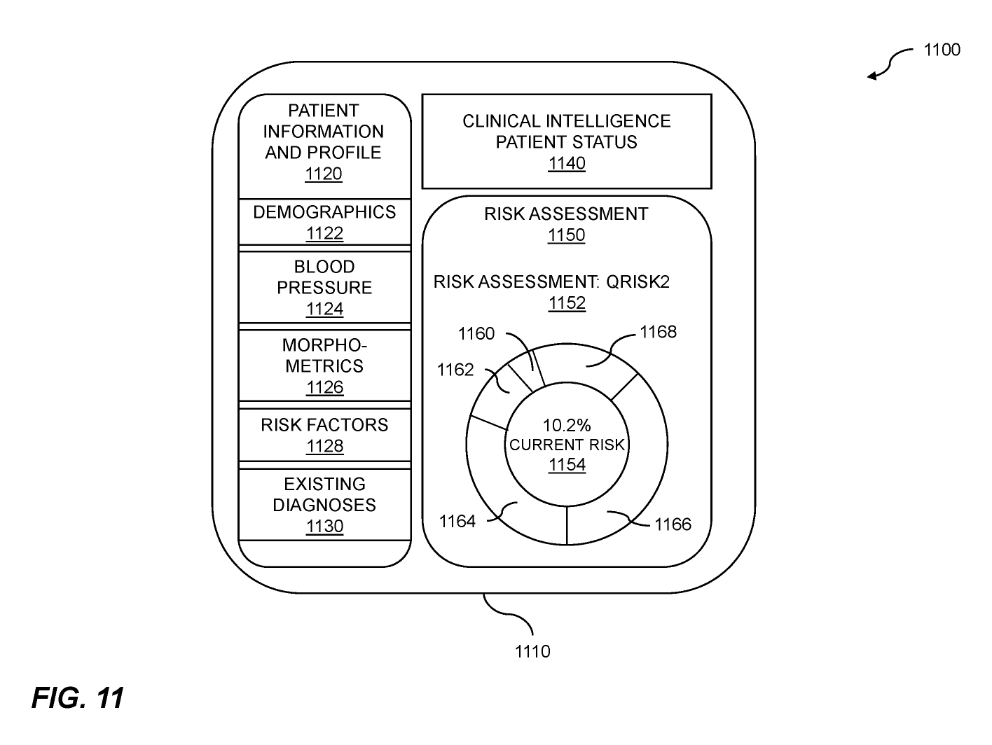

FIG. 11 is an example clinical intelligence for the doctor. The example clinical intelligence for the doctor 1100 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Example 1100 shows user interface (UI) 1110. The UI 1110 is titled Clinical Intelligence Patient Status 1140 and includes patient information and profile 1120 and risk assessment 1150. The Clinical Intelligence Patient Status 1140 shown in the UI 1110 is enabled by the medical knowledge information and the biological information. Patient information and profile 1120 can include demographics 1122, blood pressure 1124, morphometrics 1126 (quantitative body size and shape), risk factors 1128, and existing diagnoses 1130. Other patient information and profile information can be present, depending on the particular ailment of the individual patient being addressed.

Risk assessment 1150 can detail a specific risk analysis or analyses such as the risk assessment QRISK2 1152. Risk assessment QRISK2 1152 can be represented as a doughnut graph. Other such graphical representations are possible, such as pie charts, bar charts, and so on. The risk assessment QRISK2 1152 includes doughnut graph segments 1160, 1162, 1164, 1166, and 1168. The segments 1160, 1162, 1164, 1166, and 1168 show the relative percentage of risk for the various risk factors by the relative sizes of segments 1160, 1162, 1164, 1166, and 1168. The segments can correspond to the patient information and profile 1120. For example, demographics 1122 contribution to risk can be represented by segment 1160. Blood pressure 1124 contribution to risk can be represented by segment 1162. Morphometrics 1126 contribution to risk can be represented by segment 1164. Likewise, other risk factors 1128 and existing diagnoses 1130 contributions to risk can be represented by segments 1166 and 1168, respectively. The segments 1160, 1162, 1164, 1166, and 1168 can be color-coded, shaded, hatched, or otherwise distinguishable for easy interpretation. A summary of current risk 1154 is shown in the center of the doughnut graph, for example, 10.2%.

The UI 1110 can comprise a practitioner graphical user interface (GUI). The GUI can be rendered based on instructions to an application program interface (API) and shown on a display. The display can be coupled to a variety of personal and other electronic devices, including but not limited to, a computer, a laptop, a net-book, a tablet computer, a smartphone, a mobile device, a remote, a television, a projector, or the like. The practitioner GUI can display to the practitioner a wide range of information about the practitioner and about a given patient. The displayed information can include practitioner name, photograph, and account information, as well as patient name, age, current risk or risks, and so on. The patient information that is displayed to the practitioner can include general categories, and details related to the general categories. General categories can include risk assessment 1150, diagnoses (not shown), etc. Details included with the category risk factors can include body mass index (BMI), smoking status, sodium intake, blood pressure, etc. Details included with the category diagnoses can include various diagnoses and details about the diagnoses.

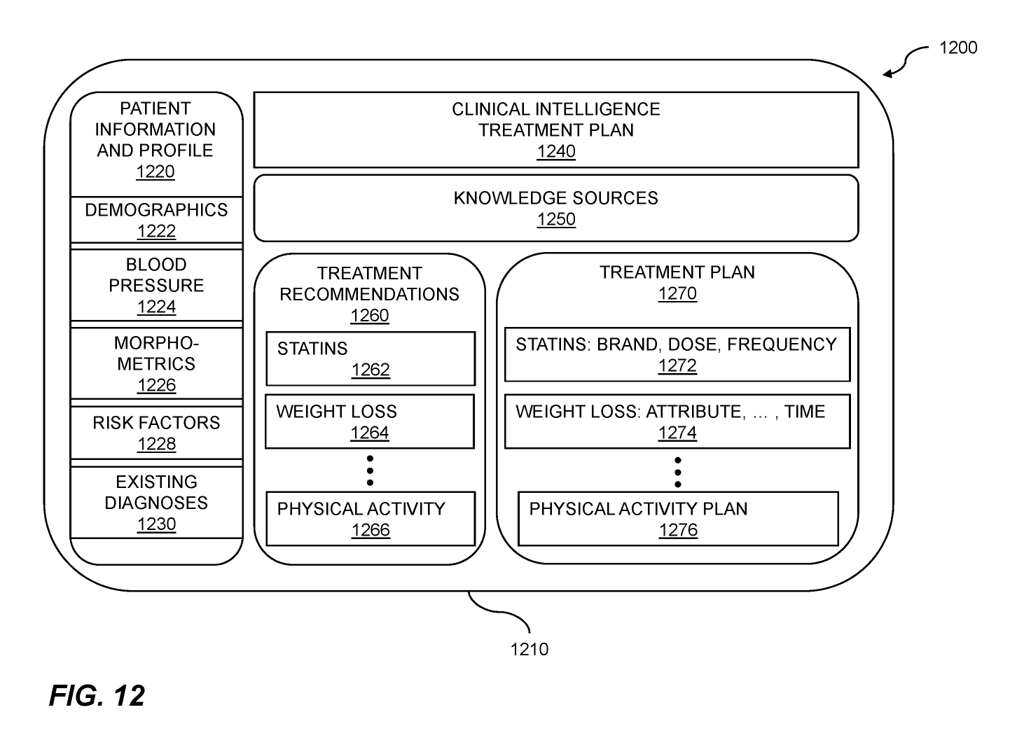

FIG. 12 shows clinical intelligence treatment recommendations and plans. The example clinical intelligence treatment recommendations and plans 1200 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Example 1200 shows user interface (UI) 1210. The UI 1210 is titled Clinical Intelligence Treatment Plan 1240 and includes patient information and profile 1220, knowledge sources 1250, treatment recommendations 1260, and treatment plan 1270. The Clinical Intelligence Treatment Plan 1240 shown in the UI 1210 is enabled by the medical knowledge information and the biological information. Patient information and profile 1220 can include demographics 1222, blood pressure 1224, morphometrics 1226 (quantitative body size and shape), other risk factors 1228, and existing diagnoses 1230. Other patient information and profile information can be present, depending on the particular ailment of the individual patient being addressed.

Knowledge sources 1250 can be a list of key references used in generating the treatment recommendations 1260 and the treatment plan 1270. The list can be enumerated in the UI 1210, or it can link to other reference material showing the knowledge sources. The treatment recommendations 1260 can include, for example, statins 1262, weight loss 1264, and physical activity, to name just a few possible treatment recommendations. The treatment plan 1270 provides details on carrying out the treatment recommendations 1260. For example, statins 1262 can be expanded to detail brand, dose, and frequency 1272. Weight loss 1264 can be expanded to include attributes, time, and so on 1274, which can comprise a weight loss plan. Physical activity 1266 can be expanded to include a physical activity plan 1276.

The UI 1210 can comprise a practitioner clinical intelligence treatment plan graphical user interface (GUI). The GUI can be rendered based on instructions to an application program interface (API) and shown on a display. The display can be coupled to a variety of personal and other electronic devices, including but not limited to, a computer, a laptop, a net-book, a tablet computer, a smartphone, a mobile device, a remote, a television, a projector, or the like. The treatment plan GUI can display to the practitioner a wide range of information about a given patient and appropriate treatment options. The displayed information can include practitioner name, photograph, and account information, as well as patient name, age, current risk or risks, and so on. The patient information that is displayed to the practitioner can include general categories, and details related to the general categories. General categories can include risk assessment (not shown) diagnoses (not shown), treatment recommendations 1260, and treatment plan 1270, to name just a few. Details included with the treatment recommendations and plan can include various options and details about the treatments. For example, the latest study results for a given treatment plan for a given diagnosis can be presented or referenced.

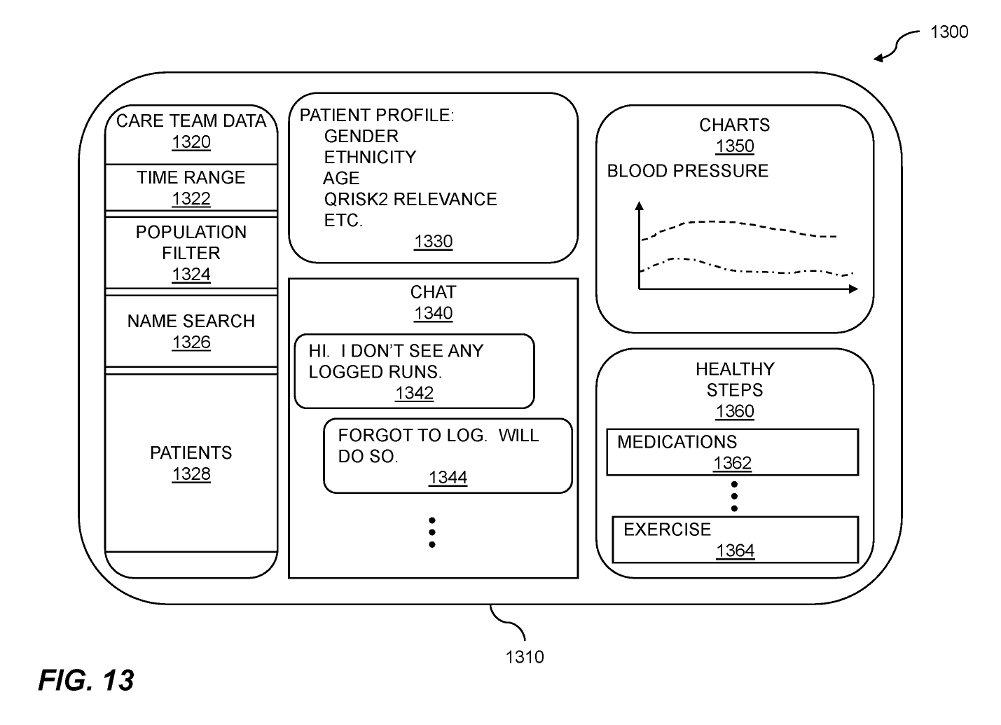

FIG. 13 is an example treatment plan of an individual for the care team. Example 1300 includes UI 1310 with Care Team data 1320, patient profile 1330, patient charts 1350, patient chat conversations 1340, and patient healthy steps 1360. The UI 1310 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. The section of the UI 1310 that contains Care Team data 1320 can include facilities to search and filter patient data by using a time range 1322, a population filter 1324, and a name search 1326. Based on the input to the facilities using a time range 1322, a population filter 1324, and/or a name search 1326, a resulting list of patients 1328 can appear. A patient can be selected from patients 1328 and relative patient data will populate the UI 1310, including the patient profile 1330 showing gender, ethnicity, age, QRISK2 relevance, etc. Likewise, relevant communication can appear in chat history window 1340, which can contain, for example, a query from the Care Team to the patient, “Hi, I don't see any logged runs” 1342. Chat history window 1340 can also display patient responses, for example, “Forgot to log, will do so” 1344, just to illustrate with a simple example. Charts 1350 will also populate based on the selected patient and can display relevant information such as a graph of blood pressure over time. Other such relevant patient information can be displayed. Healthy steps 1360 can be displayed in the UI 1310 to indicate recommendations that have been given to the patient such as medications 1362 and exercise 1364, so name just a couple.

The UI 1310 can comprise a treatment plan of an individual for the care team graphical user interface (GUI). The GUI can be rendered based on instructions to an application program interface (API) and shown on a display. The display can be coupled to a variety of personal and other electronic devices, including but not limited to, a computer, a laptop, a net-book, a tablet computer, a smartphone, a mobile device, a remote, a television, a projector, or the like. The treatment plan for the care team GUI can display to the care team a wide range of information about a given patient and appropriate treatment options, patient dialog, healthy steps, etc.

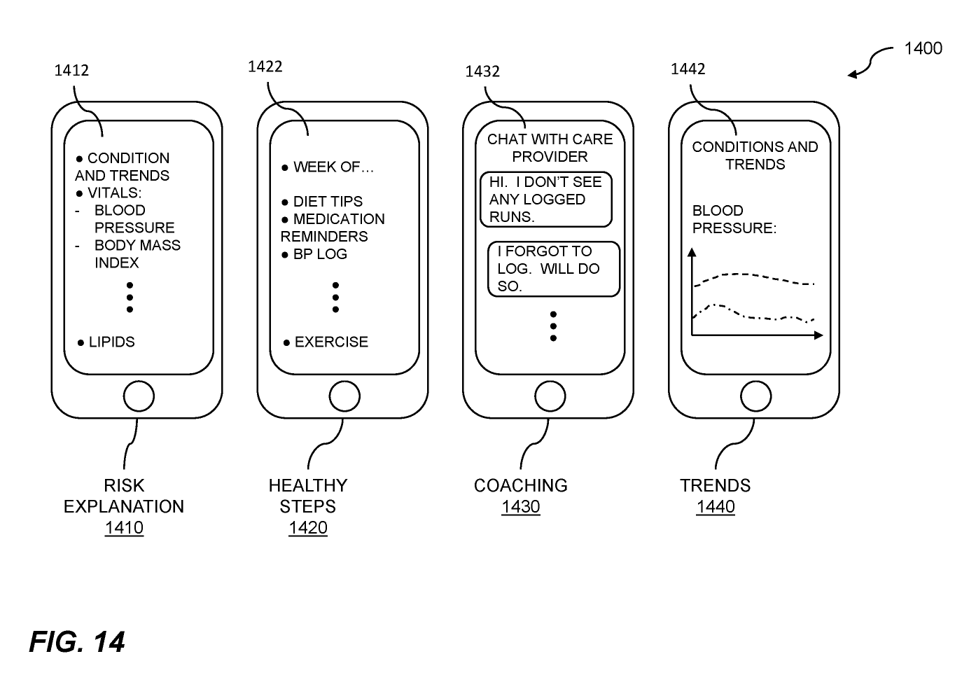

FIG. 14 is an example treatment plan for an individual patient. Example 1400 includes various display screens available to an individual patient. The screens can include a risk explanation 1410, healthy steps 1420, coaching 1430, and trends 1440. Example treatment plan screens for an individual patient 1400 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. The risk explanation screen 1410 can include condition and trends details 1412, which can display information such as vital signs and medical metrics. The vital signs can include blood pressure and body mass index (BMI), for example. The medical metrics can include lipids (LDL, HDL, HDL/LDL ratio, TG) and other metrics. The healthy steps screen 1420 can include weekly reminders and suggestions 1422 that are customized for the individual patient. The weekly reminders and suggestions 1422 can include diet tips, medication reminders, keeping a blood pressure log, and weekly exercise suggestions, to name just a few. The trends screen 1440 can include graphical depictions of the individual patient's condition and trends 1442. The individual patient's conditions and trends 1442

The coaching screen 1430 can include care team/patient interaction, coaching, encouragement and reminder information, to name just a few. The coaching screen allows for personalized communication and support between the Care Team and the individual patient. The coaching screen 1430 can include chat session 1432. The trends screen 1440 can include conditions and trends 1442. For example, a graph of blood pressure measurements over time for the individual patient can be displayed, with both systolic and diastolic metrics being graphed. Other such conditions and trends can be displayed. The example screens 1400 can comprise a treatment plan for an individual graphical user interface (GUI). The GUI can be rendered based on instructions to an application program interface (API) and shown on a display. The display can be coupled to a variety of personal and other electronic devices, including but not limited to, a computer, a laptop, a net-book, a tablet computer, a smartphone, a mobile device, a remote, a television, a projector, or the like. The treatment plan GUI can display to the individual a wide range of information about the individual patient and appropriate risk explanations, healthy steps, coaching, and trends, etc.

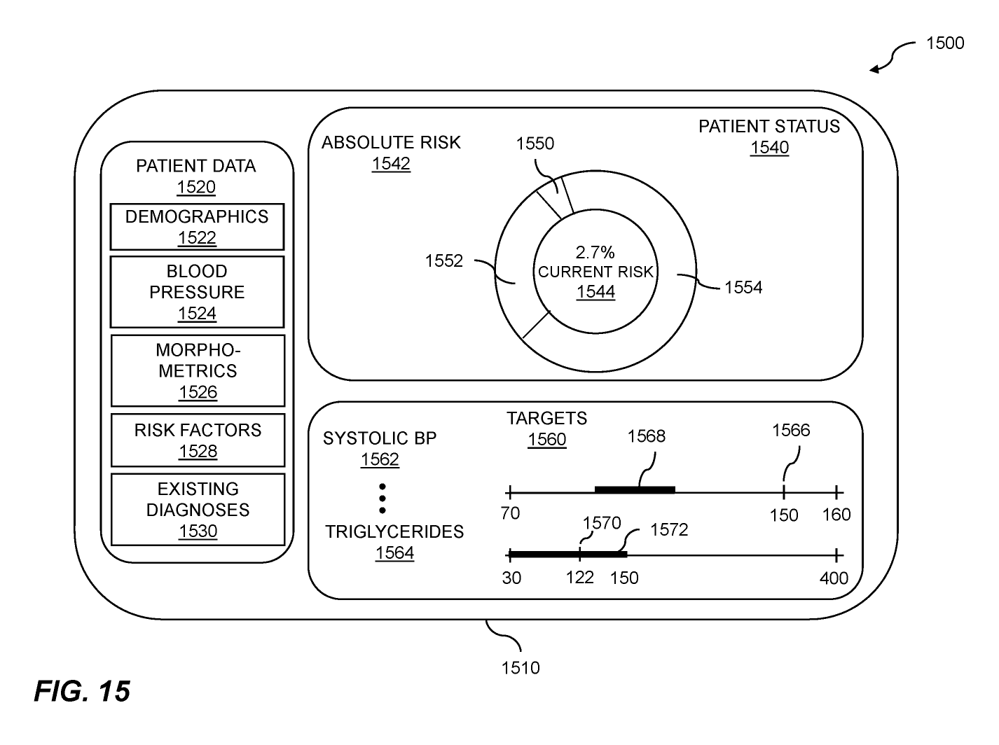

FIG. 15 is an example patient status based on medical analysis and learning. The example patient status 1500 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. Example 1500 shows user interface (UI) 1510. The UI 1510 includes patient data 1520, patient status 1540, patient absolute risk 1542, patient current risk 1544, and targets 1560. The patient data 1520 can include demographics 1522, blood pressure 1524, morphometrics 1526, other risk factors 1528, and existing diagnoses 1530. Other patient data can be present, depending on the particular ailment of the individual patient that is being addressed. The patient status 1540 can include the absolute risk 1542 of the patient's ailment, along with a doughnut graph of the risk factors. The absolute risk 1542 can represent an individual's risk within a complete demographic, such as middle-aged, Caucasian, American males. Current risk 1544 can represent a relative risk between two distinct sets within a population, such as smokers vs. non-smokers. The current risk 1544 can be broken down into risk correspondences. For example, the amount of risk represented by section 1550 of the doughnut graph can correspond to demographics 1522 factors. The amount of risk represented by section 1552 can correspond to morphometrics 1526 factors. The amount of risk represented by section 1554 can correspond to blood pressure 1524 factors. A current risk 1544 can be displayed as a summary of the relative risk inside the doughnut graph, for example 2.7%.

The UI 1510 can include targets 1560. The targets 1560 can include relevant medical metrics for an individual patient such as systolic blood pressure (BP) 1562 and triglycerides 1564. For example, a graphical representation of the individual patient's current systolic BP 1566 and desired systolic BP range 1568 are displayed. Also, a graphical representation of the individual patient's current triglycerides level 1570 and desired triglycerides range 1572 are displayed. Other relevant targets can be displayed in graphical or tabular or other formats, as appropriate. The example patient status 1500 can comprise a patient status graphical user interface (GUI). The GUI can be rendered based on instructions to an application program interface (API) and shown on a display. The display can be coupled to a variety of personal and other electronic devices, including but not limited to, a computer, a laptop, a net-book, a tablet computer, a smartphone, a mobile device, a remote, a television, a projector, or the like. The patient status GUI can display to the individual a wide range of information about the individual patient's data, status, risks, and targets, etc.

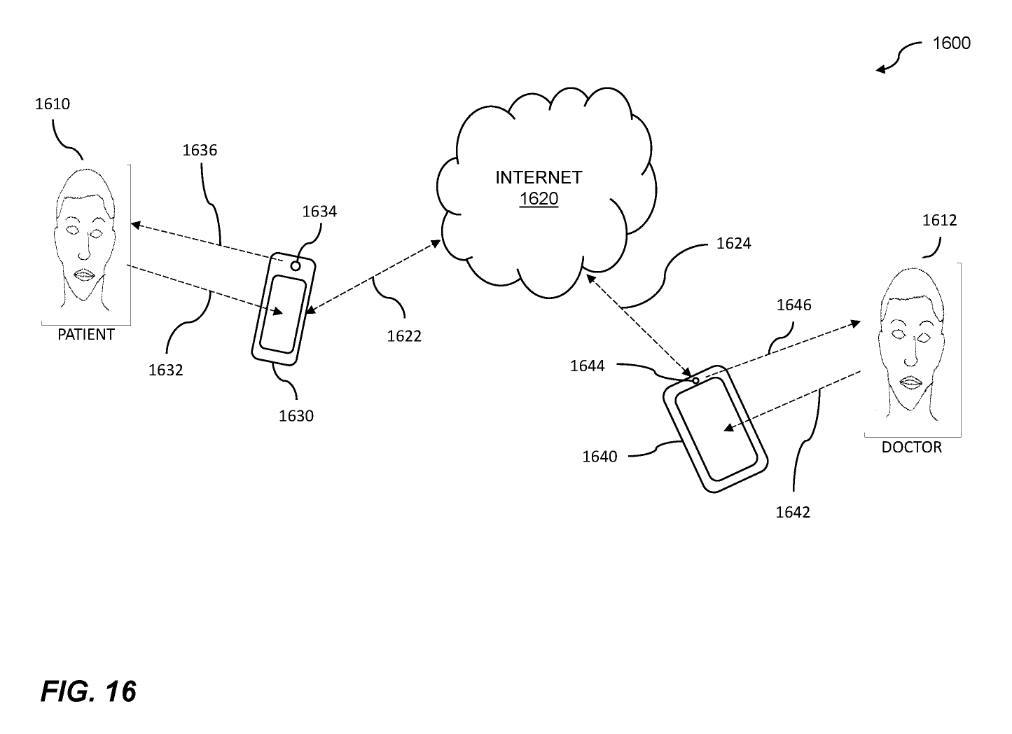

FIG. 16 illustrates a system for patient and doctor interaction. A system for patient and doctor interaction 1600 can be included in a self-learning clinical intelligence system. The self-learning clinical intelligence system can be based on biological information and medical knowledge information. The self-learning clinical intelligence system can include obtaining medical metrics, receiving biological information and other information from an individual, and applying the medical metrics to the biological information from the individual. The medical metrics can be applied to the biological information from the individual to diagnose an ailment, recommend a treatment, and so on. The system for patient and doctor interaction 1600 includes a display coupled to a portable, network-enabled electronic device 1630 to which the patient 1610 has a line-of-sight 1632. The display coupled to device 1630 can be used to show various types of information to the patient 1610 including diagnoses, recommended treatments, treatment progress, progress toward goals, etc. The portable electronic device 1630 can be a smartphone, a PDA, a tablet, a laptop computer, and so on. The portable, network-enabled electronic device 1630 can be coupled to a front-side camera 1634 with a line-of-sight 1636 to the patient 1610. The camera 1634 can capture video of the patient 1610. The captured video can be sent to one or more doctors such as doctor 1612 using a network link 1622 to the Internet 1620. The network link can be a wireless link, a wired link, and so on. In the system 1600, the patient 1610 is interacting with one doctor 1612. Each doctor (if more than one) has a line-of-sight view to a video screen on a portable, networked electronic device. In the system 1600, the doctor 1612 has a line-of-sight 1642 to a display coupled to device 1640. The device 1640 has a front-side camera 1644 with a line-of-sight 1646 to the doctor 1612. The camera 1644 can capture video of the doctor 1612, and the captured video can be sent to the patient 1610, to other doctors (if present) and so on. The captured video of the doctor 1612 can be shared using a network link 1624 to the Internet 1620. As before, the network can be a wireless link, a wired link, and so on.

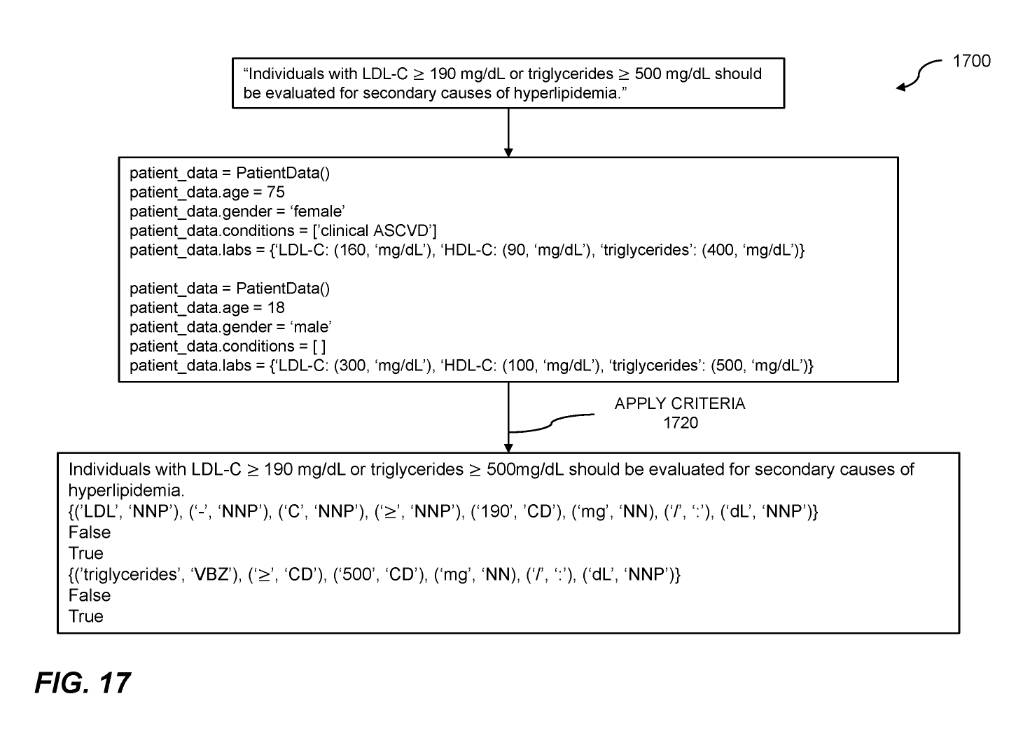

FIG. 17 illustrates natural language processing for application of criteria to patient data. A medical practitioner can be familiar with many medical conditions, diagnoses, and treatments, and can choose to interact with a self-learning clinical intelligence system using natural language (NL). The medical practitioner can pose queries, where the queries can be based on medical knowledge information, diagnoses, recommendations for treatments, and so on. Natural language processing 1700 can be applied to an NL query, NL statement, etc., to analyze biological information from an individual. Medical knowledge information can be obtained from a repository, and biological information can be collected from the individual. The biological information from the individual can be read from a file, input by a medical practitioner, provided by the individual, retrieved from medical records, collected from the individual, collected from one or more sensors, and so on. The NL processing can be used to prove the query (e.g. return positive results), to disprove the query (e.g. return negative results), and so on. The NL statement can be received where the NL statement can be related to a variety of medical conditions, diagnoses, treatments etc. Various criteria can be applied 1720 to the biological information from the individual in order to diagnose an ailment, to recommend a treatment, etc. The criteria can be encoded in a machine-readable format or other format. The criteria can be applied to the biological information from the individual based on the NL query, and the results of the query can be returned to the medical practitioner.

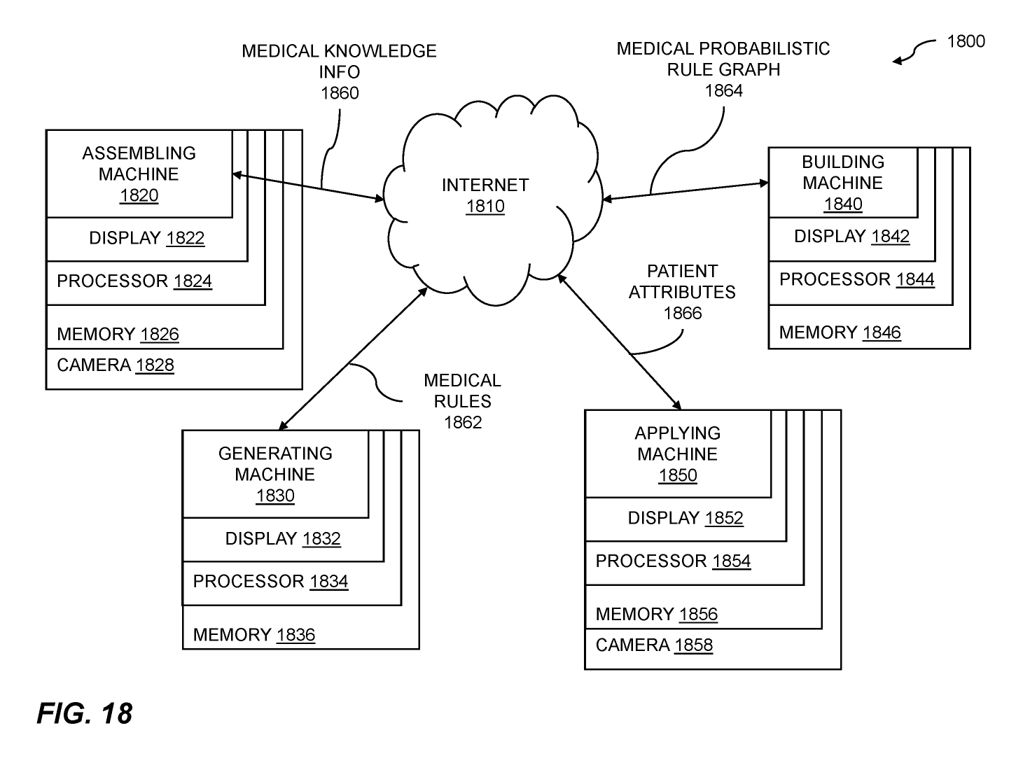

FIG. 18 illustrates a self-learning clinical intelligence system. The self-learning clinical intelligence system can include assembling medical knowledge information, generating medical rules, building a medical probabilistic rule graph, and applying patient attributes to provide a diagnosis, for an individual based on contribution of risk factors for the diagnosis using the medical knowledge information and the biological information. The self-learning clinical intelligence system can include medical analysis. The medical analysis can include recommending a treatment, for the individual, based on the ailment that was diagnosed where the treatment is recommended to a medical practitioner through a first application programming interface, and where the recommending of the treatment is based on machine learning factoring in previous diagnosing, and recommending to other individuals of treatments with information on results of effectiveness of the treatments, where the other individuals are associated with specific characteristics of the individual. The system 1800 for a self-learning clinical intelligence system can be implemented using a variety of electronic hardware and software techniques. For example, the system 1800 can be implemented using one or more machines. A system 1800 is shown for assembling medical knowledge information, generating medical rules, building a medical probabilistic rule graph, and applying patient attributes to provide a diagnosis. The system 1800 can comprise a computer system for medical analysis comprising: a memory which stores instructions; one or more processors attached to the memory wherein the one or more processors, when executing the instructions which are stored, are configured to: assemble medical knowledge information; generate medical rules based on the medical knowledge information; learn a plurality of risk models associated with a given disease based on patient attributes; build a medical probabilistic rule graph based on the medical rules and the plurality of risk models wherein the building is based on ordering the medical rules; and apply attributes, from an individual patient, to the medical probabilistic rule graph to generate a diagnosis for the individual patient.

The system 1800 can include one or more medical knowledge information assembling machines 1820 linked to one or more medical rules generating machines 1830 a via the Internet 1810 or another computer network. The network can be wired or wireless, a combination of wired and wireless networks, and so on. The generating machine 1830 can be linked to one or more medical probabilistic rule building machines 1840, also via the Internet 1810 or another computer network. The system 1800 can include one or more patient attribute-applying machines 1850. The patient attributes can include individual patient medical metrics and biological information. The medical knowledge information 1860 from the assembling machine 1820, the medical rules 1862 from the generating machine, the medical probabilistic rule graph 1864 from the building machine 1840, and the patient attributes 1866 from the applying machine 1850 can each be transferred to and/or from the other machines via the Internet 1810 or another computer network. The other computer network can be public or private, wired or wireless, high-speed or low-speed, and so on.

The assembling machine 1820 can comprise a server computer, a smart-phone, a tablet, a PDA, a laptop computer, a desktop computer, a data center, a cloud computing service, and so on. In embodiments, assembling machine 1820 comprises one or more processors 1824 coupled to a memory 1826 which can store and retrieve instructions, a display 1822, and an optional camera 1828. The camera 1828 can include a webcam, a video camera, a still camera, a thermal imager, a CCD device, a phone camera, a three-dimensional camera, a depth camera, a light field camera, a plenoptic camera, multiple webcams used to show different views of a person, or any other type of image capture technique that can allow captured data to be used in an electronic system, such as a scanner or bar code reader. The memory 1826 can be used for storing instructions, patient data, etc. The display 1822 can be any electronic display, including but not limited to, a computer display, a laptop screen, a net-book screen, a tablet computer screen, a smartphone display, a mobile device display, a remote with a display, a television, a projector, or the like. Assembled medical knowledge information 1860 can be transferred via the Internet 1810, or other computer network, for a variety of purposes including analysis, sharing, rendering, storage, cloud storage, and so on.

The generating machine 1830 can comprise a server computer, a smartphone, a tablet, a PDA, a laptop computer, a desktop computer, a data center, a cloud computing service, and so on. In embodiments, generating machine 1830 comprises one or more processors 1834 coupled to a memory 1836 which can store and retrieve instructions, and a display 1832. The memory 1836 can be used for storing instructions, patient data, etc. The display 1832 can be any electronic display, including but not limited to, a computer display, a laptop screen, a net-book screen, a tablet computer screen, a smartphone display, a mobile device display, a remote with a display, a television, a projector, or the like. Generated medical rules 1862 can be transferred via the Internet 1810, or other computer network, for a variety of purposes including analysis, sharing, rendering, storage, cloud storage, and so on.

The building machine 1840 can comprise a server computer, a smartphone, a tablet, a PDA, a laptop computer, a desktop computer, a data center, a cloud computing service, and so on. In embodiments, building machine 1840 comprises one or more processors 1844 coupled to a memory 1846 which can store and retrieve instructions, and a display 1842. The memory 1846 can be used for storing instructions, patient data, etc. The display 1842 can be any electronic display, including but not limited to, a computer display, a laptop screen, a net-book screen, a tablet computer screen, a smartphone display, a mobile device display, a remote with a display, a television, a projector, or the like. Built medical probabilistic rule graph 1864 can be transferred via the Internet 1810, or other computer network, for a variety of purposes including analysis, sharing, rendering, storage, cloud storage, and so on.

The building machine 1840 can also include a risk model learning component (not shown). The risk model learning component learns a plurality of risk models associated with a specific disease based on patient attributes. The risk models focus are based on medical metrics and biological information that combine to indicate probabilistically certain medical risks. A plurality of risk models can be learned, using one or more processors. The learning can comprise building a machine learning model. The machine learning model can be accomplished with unsupervised feature learning using non-linear combinations of patient attributes. The patient attributes can include individual biological information and medical knowledge information. Learning the plurality of risk models can comprise deep computational learning. The plurality of risk models can be based on demographics. The demographics can include age, gender, race, or geographic location, to name just a few. The plurality of risk models can be associated with a given disease based on patient attributes. The plurality of risk models can be further learned based on a result of a treatment for an individual patient. In embodiments, the risk model learning component is implemented on a distinct machine that can comprise a server computer, a smart-phone, a tablet, a PDA, a laptop computer, a desktop computer, a data center, a cloud computing service, and so on.

The applying machine 1850 can comprise a server computer, a smart-phone, a tablet, a PDA, a laptop computer, a desktop computer, a data center, a cloud computing service, and so on. In embodiments, applying machine 1850 comprises one or more processors 1854 coupled to a memory 1856 which can store and retrieve instructions, a display 1852, and an optional camera 1858. The camera 1858 can include a webcam, a video camera, a still camera, a thermal imager, a CCD device, a phone camera, a three-dimensional camera, a depth camera, a light field camera, a plenoptic camera, multiple webcams used to show different views of a person, or any other type of image capture technique that can allow captured data to be used in an electronic system, such as a scanner or bar code reader. The camera 1858 can capture biological information from an individual patient. The memory 1856 can be used for storing instructions, patient data, etc. The display 1852 can be any electronic display, including but not limited to, a computer display, a laptop screen, a net-book screen, a tablet computer screen, a smartphone display, a mobile device display, a remote with a display, a television, a projector, or the like. Applied patient attributes 1866 can be transferred via the Internet 1810, or other computer network, for a variety of purposes including analysis, sharing, rendering, storage, cloud storage, and so on. The applying machine 1850 can receive a medical probabilistic rule graph 1864 from the Internet 1810, or other computer network, and perform the application of individual patient attributes to the medical probabilistic rule graph using one or more processors 1854, which are local to the applying machine 1850. In embodiments, the one or more processors used for applying patient attributes to the medical probabilistic rule graph are not local to the applying machine 1850, but are remote in another machine or service, such as in building machine 1840, risk model learning machine (not shown), or cloud services (not shown) connected via the Internet 1810, or other computer network.

The applying machine 1850 can receive, or capture via camera 1858, patient medical and biological information for application to a medical probabilistic rule graph for generating a diagnosis, treatment recommendations based on machine learning, and the results of effectiveness of the treatments, and so on. The medical knowledge information, treatment recommendations, and results of effectiveness of the treatments can be stored in the applying machine 1850, the building machine 1840, the generating machine 1830, or the assembling machine 1820. The applying machine 1850 can provide information that can include ailment diagnoses, treatment recommendations, results of effectiveness of treatments, etc., and can be based on the self-learning clinical intelligence. In some embodiments, the applying machine 1850 receives patient attribute data from a plurality of patient data collection machines (not shown) and aggregates and processes the patient data. The applying machine 1850 can provide information for recommending a treatment, for the individual, based on an ailment that was diagnosed, where the treatment can be recommended to a medical practitioner through a first application programming interface. The resulting information can include medical knowledge information, patient biological information, results of effectiveness of treatments, etc. The resulting information can be rendered on the display 1852. The camera 1858 can be used for exchanging video data between the medical practitioner and the patient, etc. In embodiments, the rendering of the resulting information occurs on a patient data collection machine (not shown) or other machine, such as the building machine 1850.

The system 1800 can include a computer program product embodied in a non-transitory computer readable medium for medical analysis, the computer program product comprising code which causes one or more processors to perform operations of: assembling medical knowledge information; generating medical rules based on the medical knowledge information; learning a plurality of risk models associated with a given disease based on patient attributes; building a medical probabilistic rule graph based on the medical rules and the plurality of risk models wherein the building is based on ordering the medical rules; and applying attributes, from an individual patient, to the medical probabilistic rule graph to generate a diagnosis for the individual patient.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate, the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for medical analysis comprising:
assembling medical knowledge information;
generating medical rules based on the medical knowledge information;
learning, using one or more processors, a plurality of risk models associated with a given disease based on patient attributes;
building a medical probabilistic rule graph based on the medical rules and the plurality of risk models wherein the building is based on ordering the medical rules; and
applying attributes, from an individual patient, to the medical probabilistic rule graph to generate a diagnosis for the individual patient.

2. The method of claim 1 wherein a subset of the medical rules is included in the medical probabilistic rule graph.

3. The method of claim 2 wherein the medical probabilistic rule graph applies rules within the subset of the medical rules in a specific order based on the ordering.

4. The method of claim 1 wherein an output from the applying the attributes to the medical probabilistic rule graph is accomplished using probabilistic graph inference.

5. The method of claim 1 further comprising applying attributes from an individual patient to the medical probabilistic rule graph to generate a treatment for the individual patient.

6. The method of claim 5 wherein the treatment includes time-based recommendations.

7. The method of claim 6 wherein the time-based recommendations are based on simulation of conjecture scenarios.

8. The method of claim 5 wherein the learning the plurality of risk models is further based on a result of the treatment for the individual patient.

9. The method of claim 5 wherein the treatment includes personalized recommendations for the individual patient.

10. The method of claim 9 wherein the personalized recommendations for the individual patient are based on demographics of the individual patient.

11. The method of claim 1 wherein the generating medical rules includes resolving inconsistent or incomplete medical knowledge information.

12. (canceled)

13. The method of claim 1 wherein the medical knowledge information is derived from medical best practices.

14. The method of claim 1 further comprising forming a knowledge representation based on the medical knowledge information.

15. The method of claim 14 further comprising using the knowledge representation in the generating of the medical rules.

16. The method of claim 14 wherein the forming of the knowledge representation is based on medical entities.

17. (canceled)

18. The method of claim 1 wherein the medical probabilistic rule graph includes a directed acyclic graph.

19. The method of claim 1 wherein the plurality of risk models is based on demographics.

20. The method of claim 19 wherein demographics include age, gender, race, or geographic location.

21. (canceled)

22. The method of claim 1 wherein the learning the plurality of risk models comprises building a machine learning model.

23. The method of claim 22 wherein the machine learning model is accomplished with unsupervised feature learning using non-linear combinations of patient attributes.

24. The method of claim 23 wherein the patient attributes include individual biological information and medical knowledge information.

25. (canceled)

26. A computer program product embodied in a non-transitory computer readable medium for medical analysis, the computer program product comprising code which causes one or more processors to perform operations of:
assembling medical knowledge information;
generating medical rules based on the medical knowledge information;
learning a plurality of risk models associated with a given disease based on patient attributes;
building a medical probabilistic rule graph based on the medical rules and the plurality of risk models wherein the building is based on ordering the medical rules; and
applying attributes, from an individual patient, to the medical probabilistic rule graph to generate a diagnosis for the individual patient.

27. A computer system for medical analysis comprising:
a memory which stores instructions;
one or more processors attached to the memory wherein the one or more processors, when executing the instructions which are stored, are configured to:
assemble medical knowledge information;
generate medical rules based on the medical knowledge information;
learn a plurality of risk models associated with a given disease based on patient attributes;
build a medical probabilistic rule graph based on the medical rules and the plurality of risk models wherein the building is based on ordering the medical rules; and
apply attributes, from an individual patient, to the medical probabilistic rule graph to generate a diagnosis for the individual patient.
